(19) United States
(12) Patent Application Publication
(10) Pub. No.: US 2018/0039956 A1
(43) Pub. Date: Feb. 8, 2018

(54) Computer Architecture and Method for Recommending Asset Repairs

(71) Applicant: Uptake Technologies, Inc., Chicago, IL (US)

(72) Inventors: Adam McElhinney, Chicago, IL (US); Brian Silva, Algonquin, IL (US); Jung Ha Lim, Chicago, IL (US)

(21) Appl. No.: 15/231,587

(22) Filed: Aug. 8, 2016

(51) Int. Cl. G06Q 10/00; G06N 7/00; G06N 99/00; G06N 5/04

(52) U.S. Cl. CPC G06Q 10/20; G06N 5/04; G06N 7/005; G06N 99/005

(57) ABSTRACT

Disclosed herein are systems, devices, and methods related for generating a recommendation to repair an asset based on operating data. A computing system may be configured maintain a hierarchy that comprises two or more distinct levels of conditions that operating data may be checked against in order to determine which repair recommendation (if any) should be output. The hierarchy may include at least (1) a first condition that corresponds to a first repair recommendation having a first level of precision, and (2) a second condition that corresponds to a second repair recommendation having a second level of precision. Once repair recommendations are identified for satisfied conditions, the computer system may select the recommendation having the highest level of precision and then cause that recommendation to be output.

Today, machines (referred to herein as “assets”) are ubiquitous in many industries to the modern economy. From locomotives that transfer cargo across countries to farming equipment that harvest crops, assets play an important role in everyday life. Depending on the role that an asset serves, its complexity, and cost may vary. For instance, some assets may include multiple subsystems that must operate in harmony for the asset to function properly (e.g. an engine, transmission, etc. of a locomotive).

Because of the increasing role that assets play, it is also becoming increasingly desirable to repair assets with limited downtime. To facilitate this, some have developed mechanisms to monitor and detect abnormal conditions within an asset to facilitate repairing the asset, perhaps with little downtime. For instance, one approach for monitoring assets generally involves an on-asset computer that receives signals from various sensors and/or actuators distributed throughout the asset that monitor the operating conditions of the asset. As one representative example, if the asset is a locomotive, the sensors and/or actuators may monitor parameters such as temperatures, voltages, and speeds, among other examples. If the sensor and/or actuator signals from one or more of these devices reach certain values, the on-asset computer may then generate an abnormal-condition indicator, such as a “fault code,” which is an indication that an abnormal condition has occurred within the asset and repair or maintenance may be needed.

In general, an abnormal condition may be a defect at an asset or component thereof, which may lead to a failure of the asset and/or component. As such, an abnormal condition may be associated with a given failure, or perhaps multiple failures, in that the abnormal condition is symptomatic of the given failure or failures. In practice, a user typically defines the sensors and respective sensor values associated with each abnormal-condition indicator. That is, the user defines an asset's “normal” operating conditions (e.g. those that do not trigger fault codes and “abnormal” operating conditions (e.g. those that trigger fault codes).

After the on-asset computer generates an abnormal-condition indicator, the indicator and/or the sensor and/or actuator signals (which may generally be referred to as operating data) may be passed to a remote location such as a remote asset-diagnostic system, which may perform analysis on such data and/or cause information regarding asset operation to be output to a user.

### OVERVIEW

Disclosed herein are improved systems, devices, and methods for generating recommendations to repair an asset based on operating data. In some examples, a network configuration may include a communication network that facilitates communications between one or more assets, a remote computing system, and one or more data sources.

In accordance with the present disclosure, the remote computing system may maintain a hierarchy of conditions that correspond to recommendations for repairing a given aspect of an asset (e.g., a given subsystem) based on operating data. In general, the hierarchy may comprise conditions corresponding to at least two levels of repair recommendations having differing levels of precision. For instance, this hierarchy may include at least (1) a first condition that corresponds to a first repair recommendation having a first level of precision (e.g., a more granular recommendation), and (2) a second condition that corresponds to a second repair recommendation having a second level of precision (e.g., a less granular recommendation). Additionally, the hierarchy may include one or more other conditions, each of which may correspond to a repair recommendation having the first level of precision, the second level of precision, or some other level of precision.

In such a hierarchy, each of the conditions may be based on a predefined rule, a predictive model, or some combination thereof. For instance, in one embodiment, the first condition may be based on a predefined rule and the second condition may be based on a predictive model (or vice versa). Other embodiments are possible as well.

In practice, the remote computing system may apply the hierarchy to data indicative of a given asset's operating condition (i.e., operating data), such as sensor/actuator data and/or abnormal-condition data, which may be received from the given asset or some other external data source.

For instance, according to one implementation, the remote computing system may first analyze the hierarchy's conditions to determine which of the hierarchy's conditions (if any) are satisfied by the operating data for the given asset and identify the repair recommendations corresponding to the satisfied conditions. If there are two or more two or more identified repair recommendations having differing levels of precision, the remote computing system may then select the identified repair recommendation having a highest level of precision (e.g., the most granular recommendation) and then cause that repair recommendation to be output by a computing device.

As noted above, the recommendations for repairing a given asset may correspond to the conditions of the hierarchy. Generally, recommendations may be correlated to the conditions of the hierarchy by experts in the field (i.e. technicians) or by a computing device, among other entities. A recommendation, in one instance, may indicate which component(s) of an asset are in need of repair and/or provide instructions for how to repair such component(s). In some examples, the remote computing system's output of an indication of a recommendation may cause display of the recommendation via a graphical user interface and/or may cause automated performance of a repair-associated task (e.g., generation of a work order). Many other examples are also possible.

In example implementations, the precision level of a recommendation for repairing a given asset may vary dependent upon which condition of a hierarchy is satisfied (and where that condition falls within the hierarchy's levels). Broadly speaking, a recommendation corresponding a higher level of the hierarchy may be more precise/granular than a recommendation corresponding to a lower level of the hierarchy. For instance, a recommendation having a higher precision level may be directed to a specific aspect of a subsystem (e.g., a specific mechanical part such as a screw), whereas a recommendation having a lower precision level may be directed to the subsystem more generally (e.g., an engine). Moreover, the difference in precision between recommendations corresponding to distinct levels of the hierarchy may vary by any degree, and such recommendations may encompass any portion of a given asset or group of assets.

In accordance with the present disclosure, at least one condition of the hierarchy may be based on a predefined rule, which may take various forms. In one instance, the predefined rule may a rule that is based on one or both of abnormal-condition indicators (e.g., fault codes) and sensor criteria. That is, a predefined rule may require the presence of one or more abnormal-condition indicators and/or one or more sensor measurement conditions in order for the rule to be triggered. In another instance, a predefined rule may comprise a plurality of predefined rules, each defined based on a respective set of abnormal-condition indicators and/or sensor criteria. Other examples of predefined rules may also be utilized.

In one implementation, a condition based on a predefined rule may additionally include a confidence level associated with satisfaction of the predefined rule. A confidence level, in general, may be a fixed or variable metric (e.g., a number from 0 to 100) that indicates a confidence (or “trust worthiness”) in a determination that the predefined rule has been satisfied and the first recommendation for repairing a given asset is to be output. The confidence level associated with a determination that the predefined rule has been satisfied may be determined in various manners. According to one example, the confidence level may be a single fixed value that is pre-associated with satisfaction of the predefined rule. According to another example, the confidence level may be a variable value that depends on the particular operating data that led to satisfaction of the predefined rule, among other examples.

In such an implementation, the remote computing system may (1) determine that the predefined rule has been satisfied, (2) determine a confidence level associated with the satisfaction of the predefined rule, and then (3) compare that confidence level to a confidence threshold (which may be fixed or variable) in order to determine whether the first condition has been satisfied.

Further, in accordance with the present disclosure, at least one condition of the hierarchy may be based on a predictive model, which may also take various forms. In general, such a predictive model may take operating data for a given asset as input and may predict a likelihood that a given repair is needed (or will be needed in the future) based on that operating data.

The predictive model may be defined by the remote computing system based on historical data for an asset or a group of assets. This historical data may include at least operating data that indicates operating conditions of a given asset, or group of assets. Specifically, operating data may include historical abnormal-condition data identifying instances when failures occurred at assets and/or historical sensor data indicating one or more physical properties measured at the assets. The data may also include historical repair data indicating services performed on assets in the past and maintenance scheduling data detailing what services are to be performed on assets in the future, among other examples of historical data that may be used to define the predictive model.

Based on the historical data, the remote computing system may define a predictive model that predicts a likelihood that a certain repair should be made. In one instance, a predictive model may output a probability value corresponding to a recommendation for repairing a given asset. In another instance, the predictive model may output multiple probabilities corresponding to any number of recommendations. Many other forms of predictive models may exist as well.

In operation, a condition based on a predictive model may then be satisfied when the output of the predictive model exceeds a confidence threshold. Generally, a confidence threshold may be defined by a user in the field or a computing system, among other possibilities, and may further be fixed or dynamic.

Accordingly, in one aspect, disclosed herein is a method of providing a recommendation for repairing an asset that involves a computing system (a) maintaining a hierarchy of conditions that correspond to recommendations for repairing an asset based on operating data, where the hierarchy comprises at least (1) a first condition that is based on a predefined rule and corresponds to a first repair recommendation having a first level of precision and (2) a second condition that is based on a predictive model and corresponds to a second repair recommendation having a second level of precision, where the first and second levels of precision differ, (b) receiving operating data for a given asset of a plurality of assets, (c) determining that the first and second conditions of the hierarchy are satisfied by the received operating data and thereby identifying the first and second recommendations, (d) identifying which one of the first and second recommendations has a higher level of precision, and (e) causing a computing device to output an indication of the identified one of the first and second recommendations.

In another aspect, disclosed herein is a computing system that includes at least one processor, a non-transitory computer-readable medium, and program instructions stored on the non-transitory computer-readable medium that are executable by the at least one processor to cause the computing system to carry out functions disclosed herein for providing a recommendation for repairing an asset.

In yet another aspect, disclosed herein is a non-transitory computer readable medium having instructions stored thereon, where the instructions are executable by a processor to cause a computing system to carry out functions disclosed herein for providing a recommendation for repairing an asset.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts a simplified block diagram of an example asset.

FIG. 3 depicts a conceptual illustration of example abnormal-condition indicators and sensor criteria.

FIG. 4 depicts a structural diagram of an example platform.

FIG. 5 depicts an example flow diagram for analyzing a hierarchy of conditions with respect to received operating data in order to provide a repair recommendation for a given asset.

FIG. 6 depicts an example flow diagram of analyzing a condition of a hierarchy that is based on a predefined rule.

FIG. 7 depicts a conceptual illustration of data utilized by a condition of a hierarchy based on a predefined rule.

FIG. 8 depicts an example flow diagram of analyzing a condition of a hierarchy that is based on a predictive model.

FIG. 9 depicts an example flow diagram of defining a predictive model that may be used to predict a likelihood that a repair is needed.

FIG. 10 depicts an example flow diagram for applying a hierarchy of conditions to operating data in order to provide a repair recommendation for a given asset.

### DETAILED DESCRIPTION

The following disclosure makes reference to the accompanying figures and several exemplary scenarios. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example Network Configuration

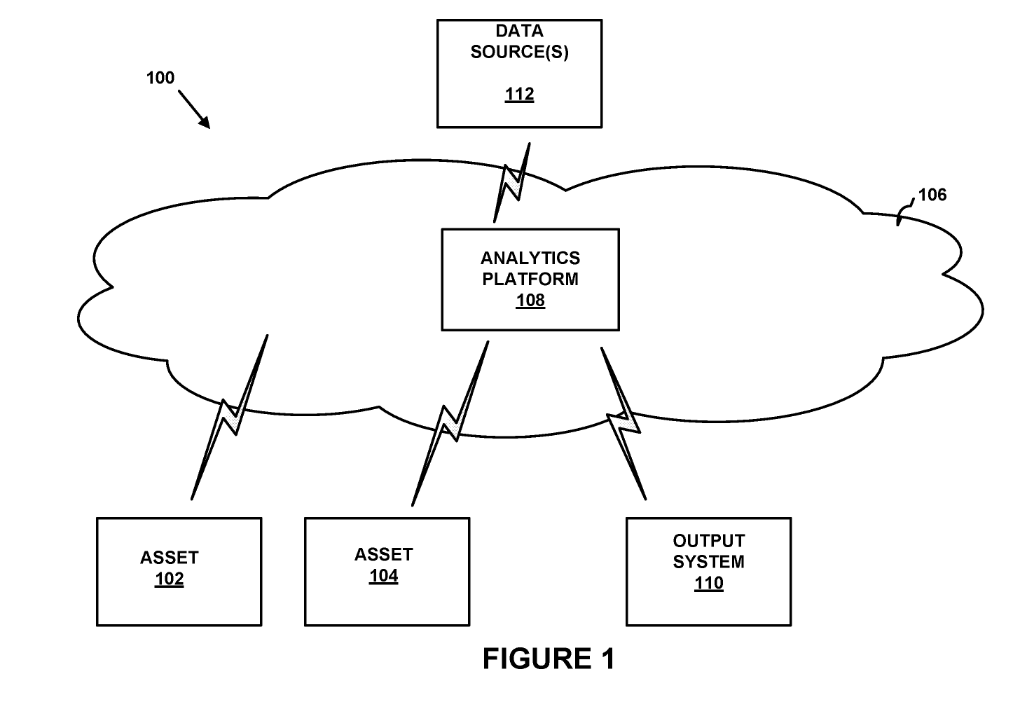

Turning now to the figures, FIG. 1 depicts an example network configuration 100 in which example embodiments may be implemented. As shown, the network configuration 100 includes an asset 102, an asset 104, a communication network 106, a remote computing system 108 that may take the form of an analytics platform, an output system 110, and a data source 112.

The communication network 106 may communicatively connect each of the components in the network configuration 100. For instance, the assets 102 and 104 may communicate with the analytics platform 108 via the communication network 106. In some cases, the assets 102 and 104 may communicate with one or more intermediary systems, such as an asset gateway or an organization's existing platform (not pictured), that in turn communicates with the analytics platform 108. Likewise, the analytics platform 108 may communicate with the output system 110 via the communication network 106. In some cases, the analytics platform 108 may communicate with one or more intermediary systems, such as a host server (not pictured), that in turn communicates with the output system 110. Many other configurations are also possible. In example cases, the communication network 106 may facilitate secure communications between network components (e.g., via encryption or other security measures).

In general, the assets 102 and 104 may take the form of any device configured to perform one or more operations (which may be defined based on the field) and may also include equipment configured to transmit data indicative of one or more operating conditions of the given asset. In some examples, an asset may include one or more subsystems configured to perform one or more respective operations. In practice, multiple subsystems may operate in parallel or sequentially in order for an asset to operate.

Example assets may include transportation machines (e.g., locomotives, aircraft, passenger vehicles, semi-trailer trucks, ships, etc.), industrial machines (e.g., mining equipment, construction equipment, processing equipment, assembly equipment, etc.), and unmanned aerial vehicles, among other examples. Those of ordinary skill in the art will appreciate that these are but a few examples of assets and that numerous others are possible and contemplated herein.

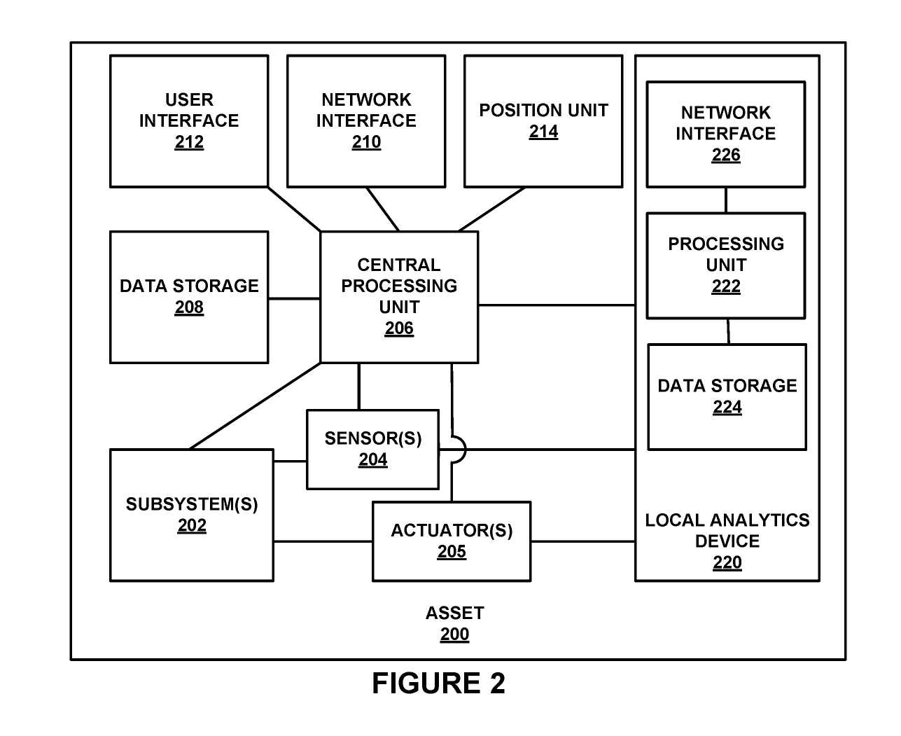

In example implementations, the assets 102 and 104 may each be of the same type (e.g., a fleet of locomotives or aircrafts, a group of wind turbines, a pool of milling machines, or a set of magnetic resonance imagining (Mill) machines, among other examples) and perhaps may be of the same class (e.g., same equipment type, brand, and/or model). In other examples, the assets 102 and 104 may differ by type, by brand, by model, etc. For example, assets 102 and 104 may be different pieces of equipment at a job site (e.g., an excavation site) or a production facility, among numerous other examples. The assets are discussed in further detail below with reference to FIG. 2.

As shown, the assets 102 and 104, and perhaps the data source 112, may communicate with the analytics platform 108 via the communication network 106. In general, the communication network 106 may include one or more computing systems and network infrastructure configured to facilitate transferring data between network components. The communication network 106 may be or may include one or more Wide-Area Networks (WANs) and/or Local-Area Networks (LANs), which may be wired and/or wireless and may support secure communication. In some examples, the communication network 106 may include one or more cellular networks and/or the Internet, among other networks. The communication network 106 may operate according to one or more communication protocols, such as LTE, CDMA, GSM, LPWAN, WiFi, Bluetooth, Ethernet, HTTP/S, TCP, CoAP/DTLS and the like. Although the communication network 106 is shown as a single network, it should be understood that the communication network 106 may include multiple, distinct networks that are themselves communicatively linked. The communication network 106 could take other forms as well.

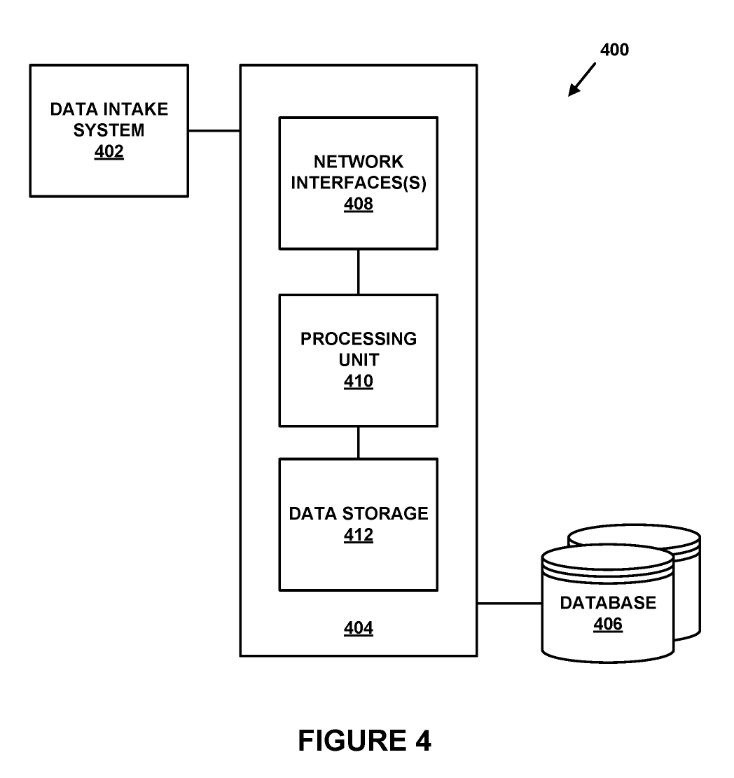

As noted above, the analytics platform 108 (sometimes referred to herein as a “remote-asset monitoring system”) may be configured to receive data from the assets 102 and 104 and the data source 112. Broadly speaking, the analytics platform 108 may include one or more computing systems, such as servers and databases, configured to receive, process, analyze, and output data. The analytics platform 108 may be configured according to a given dataflow technology, such as TPL Dataflow or NiFi, among other examples. The analytics platform 108 is discussed in further detail below with reference to FIG. 4.

As shown, the analytics platform 108 may be configured to transmit data to the assets 102 and 104 and/or to the output system 110. The particular data transmitted may take various forms and will be described in further detail below.

In general, the output system 110 may take the form of a computing system or device configured to receive data and provide some form of output based on the received data. The output system 110 may take various forms. In one example, the output system 110 may be or include a client station that is generally configured to configured to communicate with other computing systems and/or devices via the communication network 106, receive user input, process data, and provide a visual, audio, and/or tactile output to a user (e.g., based on data received via the communication network 106). Examples of client stations include tablets, smartphones, laptop computers, other mobile computing devices, desktop computers, smart televisions, and the like.

Another example of the output system 110 may take the form of a work-order system configured to output a request for a mechanic or the like to repair an asset. Yet another example of the output system 110 may take the form of a parts-ordering system configured to place an order for a part of an asset and output a receipt thereof. Numerous other examples of output systems are also possible.

The data source 112 may be configured to communicate with the analytics platform 108. In general, the data source 112 may be or include one or more computing systems configured to collect, store, and/or provide to other systems, such as the analytics platform 108, data that may be relevant to the functions performed by the analytics platform 108. The data source 112 may be configured to generate and/or obtain data independently from the assets 102 and 104. As such, the data provided by the data source 112 may be referred to herein as “external data.” The data source 112 may be configured to provide current and/or historical data. In practice, the analytics platform 108 may receive data from the data source 112 by “subscribing” to a service provided by the data source. However, the analytics platform 108 may receive data from the data source 112 in other manners as well. Examples of the data source 112 include asset-management data sources, environment data sources, and other data sources.

In general, asset-management data sources provide data indicating events or statuses of entities (e.g., other assets) that may affect the operation or maintenance of assets (e.g., when and where an asset may operate or receive maintenance). Examples of asset-management data sources include asset-repair servers that provide information regarding repairs and services that have been performed and/or are scheduled to be performed on assets, repair-shop servers that provide information regarding repair shop capacity and the like, traffic-data servers that provide information regarding air, water, and/or ground traffic, asset-schedule servers that provide information regarding expected routes and/or locations of assets on particular dates and/or at particular times, defect detector systems (also known as “hotbox” detectors) that provide information regarding one or more operating conditions of an asset that passes in proximity to the defect detector system, and part-supplier servers that provide information regarding parts that particular suppliers have in stock and prices thereof, among other examples.

In general, environment data sources provide data indicating some characteristic of the environment in which assets are operated. Examples of environment data sources include weather-data servers, global navigation satellite systems (GNSS) servers, map-data servers, and topography-data servers that provide information regarding natural and artificial features of a given area, among other examples.

Examples of other data sources include power-grid servers that provide information regarding electricity consumption and external databases that store historical operating data for assets, among other examples. One of ordinary skill in the art will appreciate that these are but a few examples of data sources and that numerous others are possible.

It should be understood that the network configuration 100 is one example of a network in which embodiments described herein may be implemented. Numerous other arrangements are possible and contemplated herein. For instance, other network configurations may include additional components not pictured and/or more or less of the pictured components.

### II. Example Asset

Turning to FIG. 2, a simplified block diagram of an example asset 200 is depicted. Either or both of assets 102 and 104 from FIG. 1 may be configured like the asset 200. As shown, the asset 200 may include one or more subsystems 202, one or more sensors 204, one or more actuators 205, a central processing unit 206, data storage 208, a network interface 210, a user interface 212, a position unit 214, and perhaps also a local analytics device 220, all of which may be communicatively linked (either directly or indirectly) by a system bus, network, or other connection mechanism. One of ordinary skill in the art will appreciate that the asset 200 may include additional components not shown and/or more or less of the depicted components.

Broadly speaking, the asset 200 may include one or more electrical, mechanical, and/or electromechanical components configured to perform one or more operations. In some cases, one or more components may be grouped into a given subsystem 202.

Generally, a subsystem 202 may include a group of related components that are part of the asset 200. A single subsystem 202 may independently perform one or more operations or the single subsystem 202 may operate along with one or more other subsystems to perform one or more operations. Typically, different types of assets, and even different classes of the same type of assets, may include different subsystems.

For instance, in the context of transportation assets, examples of subsystems 202 may include engines, transmissions, drivetrains, fuel systems, battery systems, exhaust systems, braking systems, electrical systems, signal processing systems, generators, gear boxes, rotors, and hydraulic systems, among numerous other subsystems.

As suggested above, the asset 200 may be outfitted with various sensors 204 that are configured to monitor operating conditions of the asset 200 and various actuators 205 that are configured to interact with the asset 200 or a component thereof and monitor operating conditions of the asset 200. In some cases, some of the sensors 204 and/or actuators 205 may be grouped based on a particular subsystem 202. In this way, the group of sensors 204 and/or actuators 205 may be configured to monitor operating conditions of the particular subsystem 202, and the actuators from that group may be configured to interact with the particular subsystem 202 in some way that may alter the subsystem's behavior based on those operating conditions.

In general, a sensor 204 may be configured to detect a physical property, which may be indicative of one or more operating conditions of the asset 200, and provide an indication, such as an electrical signal, of the detected physical property. In operation, the sensors 204 may be configured to obtain measurements continuously, periodically (e.g., based on a sampling frequency), and/or in response to some triggering event. In some examples, the sensors 204 may be preconfigured with operating parameters for performing measurements and/or may perform measurements in accordance with operating parameters provided by the central processing unit 206 (e.g., sampling signals that instruct the sensors 204 to obtain measurements). In examples, different sensors 204 may have different operating parameters (e.g., some sensors may sample based on a first frequency, while other sensors sample based on a second, different frequency). In any event, the sensors 204 may be configured to transmit electrical signals indicative of a measured physical property to the central processing unit 206. The sensors 204 may continuously or periodically provide such signals to the central processing unit 206.

For instance, sensors 204 may be configured to measure physical properties such as the location and/or movement of the asset 200, in which case the sensors may take the form of GNSS sensors, dead-reckoning-based sensors, accelerometers, gyroscopes, pedometers, magnetometers, or the like. In example embodiments, one or more such sensors may be integrated with or located separate from the position unit 214, discussed below.

Additionally, various sensors 204 may be configured to measure other operating conditions of the asset 200, examples of which may include temperatures, pressures, speeds, acceleration or deceleration rates, friction, power usages, fuel usages, fluid levels, runtimes, voltages and currents, magnetic fields, electric fields, presence or absence of objects, positions of components, and power generation, among other examples. One of ordinary skill in the art will appreciate that these are but a few example operating conditions that sensors may be configured to measure. Additional or fewer sensors may be used depending on the industrial application or specific asset.

As suggested above, an actuator 205 may be configured similar in some respects to a sensor 204. Specifically, an actuator 205 may be configured to detect a physical property indicative of an operating condition of the asset 200 and provide an indication thereof in a manner similar to the sensor 204.

Moreover, an actuator 205 may be configured to interact with the asset 200, one or more subsystems 202, and/or some component thereof. As such, an actuator 205 may include a motor or the like that is configured to perform a mechanical operation (e.g., move) or otherwise control a component, subsystem, or system. In a particular example, an actuator may be configured to measure a fuel flow and alter the fuel flow (e.g., restrict the fuel flow), or an actuator may be configured to measure a hydraulic pressure and alter the hydraulic pressure (e.g., increase or decrease the hydraulic pressure). Numerous other example interactions of an actuator are also possible and contemplated herein.

Generally, the central processing unit 206 may include one or more processors and/or controllers, which may take the form of a general- or special-purpose processor or controller. In particular, in example implementations, the central processing unit 206 may be or include microprocessors, microcontrollers, application specific integrated circuits, digital signal processors, and the like. In turn, the data storage 208 may be or include one or more non-transitory computer-readable storage media, such as optical, magnetic, organic, or flash memory, among other examples.

The central processing unit 206 may be configured to store, access, and execute computer-readable program instructions stored in the data storage 208 to perform the operations of an asset described herein. For instance, as suggested above, the central processing unit 206 may be configured to receive respective sensor signals from the sensors 204 and/or actuators 205. The central processing unit 206 may be configured to store sensor and/or actuator data in and later access it from the data storage 208.

The central processing unit 206 may also be configured to determine whether received sensor and/or actuator signals trigger any abnormal-condition indicators, such as fault codes. For instance, the central processing unit 206 may be configured to store in the data storage 208 abnormal-condition rules, each of which include a given abnormal-condition indicator representing a particular abnormal condition and respective triggering criteria that trigger the abnormal-condition indicator. That is, each abnormal-condition indicator corresponds with one or more sensor and/or actuator measurement values that must be satisfied before the abnormal-condition indicator is triggered. In practice, the asset 200 may be pre-programmed with the abnormal-condition rules and/or may receive new abnormal-condition rules or updates to existing rules from a computing system, such as the analytics platform 108.

In any event, the central processing unit 206 may be configured to determine whether received sensor and/or actuator signals trigger any abnormal-condition indicators. That is, the central processing unit 206 may determine whether received sensor and/or actuator signals satisfy any triggering criteria. When such a determination is affirmative, the central processing unit 206 may generate abnormal-condition data and then may also cause the asset's network interface 210 to transmit the abnormal-condition data to the analytics platform 108 and/or cause the asset's user interface 212 to output an indication of the abnormal condition, such as a visual and/or audible alert. Additionally, the central processing unit 206 may log the occurrence of the abnormal-condition indicator being triggered in the data storage 208, perhaps with a timestamp.

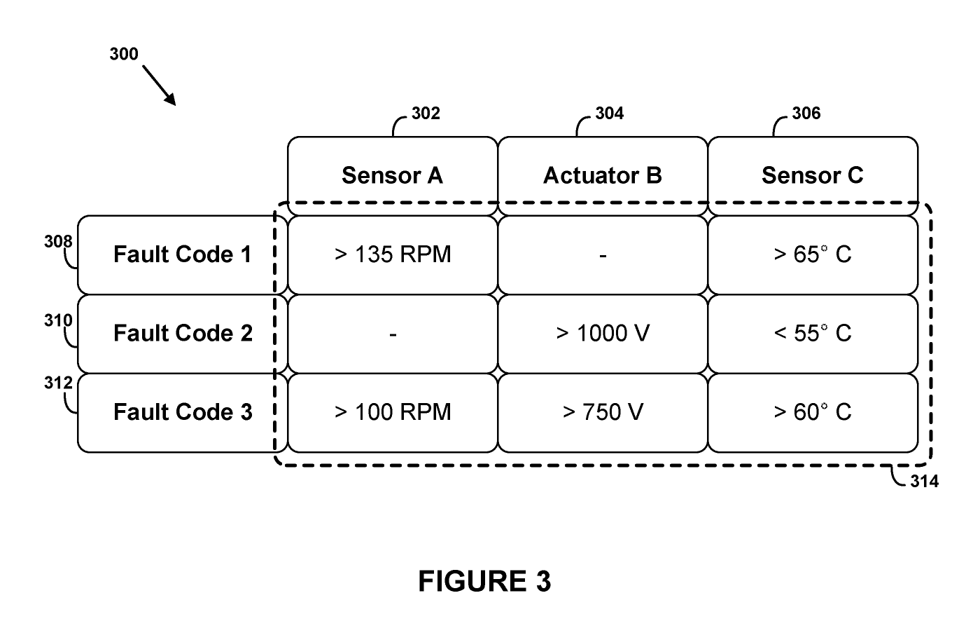

FIG. 3 depicts a conceptual illustration of example abnormal-condition indicators and respective triggering criteria for an asset. In particular, FIG. 3 depicts a conceptual illustration of example fault codes. As shown, table 300 includes columns 302, 304, and 306 that correspond to Sensor A, Actuator B, and Sensor C, respectively, and rows 308, 310, and 312 that correspond to Fault Codes 1, 2, and 3, respectively. Entries 314 then specify sensor criteria (e.g., sensor value thresholds) that correspond to the given fault codes.

For example, Fault Code 1 will be triggered when Sensor A detects a rotational measurement greater than 135 revolutions per minute (RPM) and Sensor C detects a temperature measurement greater than 65° Celsius (C), Fault Code 2 will be triggered when Actuator B detects a voltage measurement greater than 1000 Volts (V) and Sensor C detects a temperature measurement less than 55° C., and Fault Code 3 will be triggered when Sensor A detects a rotational measurement greater than 100 RPM, Actuator B detects a voltage measurement greater than 750 V, and Sensor C detects a temperature measurement greater than 60° C. One of ordinary skill in the art will appreciate that FIG. 3 is provided for purposes of example and explanation only and that numerous other fault codes and/or triggering criteria are possible and contemplated herein.

Referring back to FIG. 2, the central processing unit 206 may be configured to carry out various additional functions for managing and/or controlling operations of the asset 200 as well. For example, the central processing unit 206 may be configured to provide instruction signals to the subsystems 202 and/or the actuators 205 that cause the subsystems 202 and/or the actuators 205 to perform some operation, such as modifying a throttle position. Additionally, the central processing unit 206 may be configured to modify the rate at which it processes data from the sensors 204 and/or the actuators 205, or the central processing unit 206 may be configured to provide instruction signals to the sensors 204 and/or actuators 205 that cause the sensors 204 and/or actuators 205 to, for example, modify a sampling rate. Moreover, the central processing unit 206 may be configured to receive signals from the subsystems 202, the sensors 204, the actuators 205, the network interfaces 210, the user interfaces 212, and/or the position unit 214 and based on such signals, cause an operation to occur. Further still, the central processing unit 206 may be configured to receive signals from a computing device, such as a diagnostic device, that cause the central processing unit 206 to execute one or more diagnostic tools in accordance with diagnostic rules stored in the data storage 208. Other functionalities of the central processing unit 206 are discussed below.

The network interface 210 may be configured to provide for communication between the asset 200 and various network components connected to the communication network 106. For example, the network interface 210 may be configured to facilitate wireless communications to and from the communication network 106 and may thus take the form of an antenna structure and associated equipment for transmitting and receiving various over-the-air signals. Other examples are possible as well. In practice, the network interface 210 may be configured according to a communication protocol, such as but not limited to any of those described above.

The user interface 212 may be configured to facilitate user interaction with the asset 200 and may also be configured to facilitate causing the asset 200 to perform an operation in response to user interaction. Examples of user interfaces 212 include touch-sensitive interfaces, mechanical interfaces (e.g., levers, buttons, wheels, dials, keyboards, etc.), and other input interfaces (e.g., microphones), among other examples. In some cases, the user interface 212 may include or provide connectivity to output components, such as display screens, speakers, headphone jacks, and the like.

The position unit 214 may be generally configured to facilitate performing functions related to geo-spatial location/position and/or navigation. More specifically, the position unit 214 may be configured to facilitate determining the location/position of the asset 200 and/or tracking the asset 200's movements via one or more positioning technologies, such as a GNSS technology (e.g., GPS, GLONASS, Galileo, BeiDou, or the like), triangulation technology, and the like. As such, the position unit 214 may include one or more sensors and/or receivers that are configured according to one or more particular positioning technologies.

In example embodiments, the position unit 214 may allow the asset 200 to provide to other systems and/or devices (e.g., the analytics platform 108) position data that indicates the position of the asset 200, which may take the form of GPS coordinates, among other forms. In some implementations, the asset 200 may provide to other systems position data continuously, periodically, based on triggers, or in some other manner. Moreover, the asset 200 may provide position data independent of or along with other asset-related data (e.g., along with operating data).

The local analytics device 220 may generally be configured to receive and analyze data related to the asset 200 and based on such analysis, may cause one or more operations to occur at the asset 200. For instance, the local analytics device 220 may receive operating data for the asset 200 (e.g., data generated by the sensors 204 and/or actuators 205) and based on such data, may provide instructions to the central processing unit 206, the sensors 204, and/or the actuators 205 that cause the asset 200 to perform an operation. In another example, the local analytics device 220 may receive location data from the position unit 214 and based on such data, may modify how it handles predictive models and/or workflows for the asset 200. Other example analyses and corresponding operations are also possible.

To facilitate some of these operations, the local analytics device 220 may include one or more asset interfaces that are configured to couple the local analytics device 220 to one or more of the asset's on-board systems. For instance, as shown in FIG. 2, the local analytics device 220 may have an interface to the asset's central processing unit 206, which may enable the local analytics device 220 to receive data from the central processing unit 206 (e.g., operating data that is generated by sensors 204 and/or actuators 205 and sent to the central processing unit 206, or position data generated by the position unit 214) and then provide instructions to the central processing unit 206. In this way, the local analytics device 220 may indirectly interface with and receive data from other on-board systems of the asset 200 (e.g., the sensors 204 and/or actuators 205) via the central processing unit 206. Additionally or alternatively, as shown in FIG. 2, the local analytics device 220 could have an interface to one or more sensors 204 and/or actuators 205, which may enable the local analytics device 220 to communicate directly with the sensors 204 and/or actuators 205. The local analytics device 220 may interface with the on-board systems of the asset 200 in other manners as well, including the possibility that the interfaces illustrated in FIG. 2 are facilitated by one or more intermediary systems that are not shown.

In practice, the local analytics device 220 may enable the asset 200 to locally perform advanced analytics and associated operations, such as executing a predictive model and corresponding workflow, that may otherwise not be able to be performed with the other on-asset components. As such, the local analytics device 220 may help provide additional processing power and/or intelligence to the asset 200.

It should be understood that the local analytics device 220 may also be configured to cause the asset 200 to perform operations that are not related to a predictive model. For example, the local analytics device 220 may receive data from a remote source, such as the analytics platform 108 or the output system 110, and based on the received data cause the asset 200 to perform one or more operations. One particular example may involve the local analytics device 220 receiving a firmware update for the asset 200 from a remote source and then causing the asset 200 to update its firmware. Another particular example may involve the local analytics device 220 receiving a diagnosis instruction from a remote source and then causing the asset 200 to execute a local diagnostic tool in accordance with the received instruction. Numerous other examples are also possible.

As shown, in addition to the one or more asset interfaces discussed above, the local analytics device 220 may also include a processing unit 222, a data storage 224, and a network interface 226, all of which may be communicatively linked by a system bus, network, or other connection mechanism. The processing unit 222 may include any of the components discussed above with respect to the central processing unit 206. In turn, the data storage 224 may be or include one or more non-transitory computer-readable storage media, which may take any of the forms of computer-readable storage media discussed above.

The processing unit 222 may be configured to store, access, and execute computer-readable program instructions stored in the data storage 224 to perform the operations of a local analytics device described herein. For instance, the processing unit 222 may be configured to receive respective sensor and/or actuator signals generated by the sensors 204 and/or actuators 205 and may execute a predictive model and corresponding workflow based on such signals. Other functions are described below.

The network interface 226 may be the same or similar to the network interfaces described above. In practice, the network interface 226 may facilitate communication between the local analytics device 220 and the analytics platform 108.

In some example implementations, the local analytics device 220 may include and/or communicate with a user interface that may be similar to the user interface 212. In practice, the user interface may be located remote from the local analytics device 220 (and the asset 200). Other examples are also possible.

While FIG. 2 shows the local analytics device 220 physically and communicatively coupled to its associated asset (e.g., the asset 200) via one or more asset interfaces, it should also be understood that this might not always be the case. For example, in some implementations, the local analytics device 220 may not be physically coupled to its associated asset and instead may be located remote from the asset 200. In an example of such an implementation, the local analytics device 220 may be wirelessly, communicatively coupled to the asset 200. Other arrangements and configurations are also possible.

For more detail regarding the configuration and operation of a local analytics device, please refer to U.S. patent application Ser. No. 14/963,207, which is incorporated by reference herein in its entirety.

One of ordinary skill in the art will appreciate that the asset 200 shown in FIG. 2 is but one example of a simplified representation of an asset and that numerous others are also possible. For instance, other assets may include additional components not pictured and/or more or less of the pictured components. Moreover, a given asset may include multiple, individual assets that are operated in concert to perform operations of the given asset. Other examples are also possible.

### III. Example Platform

Referring now to FIG. 4, a simplified block diagram of an example analytics platform 400 is depicted. As suggested above, the analytics platform 400 may include one or more computing systems communicatively linked and arranged to carry out various operations described herein. For instance, as shown, the analytics platform 400 may include a data intake system 402, a data analysis system 404, and one or more databases 406. These system components may be communicatively coupled via one or more wireless and/or wired connections, which may be configured to facilitate secure communications. Further, two or more of these components may be integrated together in whole or in part.

The data intake system 402 may generally function to receive data and then ingest at least a portion of the received data for output to the data analysis system 404. As such, the data intake system 402 may include one or more network interfaces configured to receive data from various network components of the network configuration 100, such as the assets 102 and 104, the output system 110, the data source 112, and/or one or more intermediary systems. Specifically, the data intake system 402 may be configured to receive analog signals, data streams, and/or network packets, among other examples. As such, the network interfaces may include one or more wired network interfaces, such as a port or the like, and/or wireless network interfaces, similar to those described above. In some examples, the data intake system 402 may be or include components configured according to a given dataflow technology, such as a NiFi receiver or the like.

The data intake system 402 may include one or more processing components configured to perform one or more operations. Example operations may include compression and/or decompression, encryption and/or de-encryption, analog-to-digital and/or digital-to-analog conversion, amplification, formatting, and packaging, among other operations. Moreover, the data intake system 402 may be configured to filter, parse, sort, organize, route, and/or store data in accordance with one or more intake parameters. For example, the data intake system 402 may operate in accordance with an intake parameter that defines the particular set of data variables to intake from an asset (e.g., the particular set of asset sensor/actuator readings to be ingested). As another example, the data intake system 402 may operate in accordance with an intake parameter that defines a rate at which to intake data from an asset (e.g., a sampling frequency). As yet another example, the data intake system 402 may operate in accordance with an intake parameter that defines a storage location for data ingested from an asset. The data intake system 402 may operate in accordance with other intake parameters as well.

In general, the data received by the data intake system 402 may take various forms. For example, the payload of the data may include operating data such as a single sensor or actuator measurement, multiple sensor and/or actuator measurements, abnormal-condition data, and/or other data regarding the operation of an asset. Other examples are also possible.

Moreover, the received data may include other data corresponding to the operating data, such as a source identifier, a timestamp (e.g., a date and/or time at which the information was obtained), and/or location data. For instance, a unique identifier (e.g., a computer generated alphabetic, numeric, alphanumeric, or the like identifier) may be assigned to each asset, and perhaps to each sensor and actuator. Such identifiers may be operable to identify the asset, sensor, or actuator from which data originates. Further, the location data may represent the location of the asset (e.g., in the form of GPS coordinates or the like), and in certain cases, the location data may correspond to the location of the asset when certain information was obtained, such as operating data. In practice, the other data corresponding to the operating data may take the form of signal signatures or metadata, among other examples.

The data analysis system 404 may generally function to receive (e.g., from the data intake system 402) and analyze data and based on such analysis, cause one or more operations to occur. As such, the data analysis system 404 may include one or more network interfaces 408, a processing unit 410, and data storage 412, all of which may be communicatively linked by a system bus, network, or other connection mechanism. In some cases, the data analysis system 404 may be configured to store and/or access one or more application program interfaces (APIs) that facilitate carrying out some of the functionality disclosed herein.

The network interfaces 408 may be the same or similar to any network interface described above. In practice, the network interfaces 408 may facilitate communication (e.g., with some level of security) between the data analysis system 404 and various other entities, such as the data intake system 402, the databases 406, the assets 102, the output system 110, etc.

The processing unit 410 may include one or more processors, which may take any of the processor forms described above. In turn, the data storage 412 may be or include one or more non-transitory computer-readable storage media, which may take any of the forms of computer-readable storage media discussed above. The processing unit 410 may be configured to store, access, and execute computer-readable program instructions stored in the data storage 412 to perform the operations of an analytics platform described herein.

In general, the processing unit 410 may be configured to perform analytics on data received from the data intake system 402. To that end, the processing unit 410 may be configured to execute one or more modules, which may each take the form of one or more sets of program instructions that are stored in the data storage 412. The modules may be configured to facilitate causing an outcome to occur based on the execution of the respective program instructions. An example outcome from a given module may include outputting data into another module, updating the program instructions of the given module and/or of another module, and outputting data to a network interface 408 for transmission to an asset and/or the output system 110, among other examples.

The databases 406 may generally function to receive (e.g., from the data analysis system 404) and store data. As such, each database 406 may include one or more non-transitory computer-readable storage media, such as any of the examples provided above. In practice, the databases 406 may be separate from or integrated with the data storage 412.

The databases 406 may be configured to store numerous types of data, some of which is discussed below. In practice, some of the data stored in the databases 406 may include a timestamp indicating a date and time at which the data was generated or added to the database. Additionally or alternatively, some of the data stored in the databases 406 may include repair data for various assets. The data stored in databases 406 may take various other forms as well.

Moreover, data may be stored in a number of manners in the databases 406. For instance, data may be stored in time sequence, in a tabular manner, and/or organized based on data source type (e.g., based on asset, asset type, sensor, sensor type, actuator, actuator type, or asset position) or abnormal-condition indicator, among other examples. The databases may also have different storage characteristics, such as different levels of durability, accessibility and/or reliability. Representative examples of database types may include time-series databases, document databases, relational databases, and graph databases, among others.

It should be understood that the analytics platform 400 may take other forms and include other systems and/or components as well. For example, the analytics platform 400 could include a system that determines and/or tracks asset location. Other examples are possible as well.

### IV. Example Operations

The operations of the example network configuration 100 depicted in FIG. 1 will now be discussed in further detail below. To help describe some of these operations, flow diagrams may be referenced to describe combinations of operations that may be performed. In some cases, each block may represent a module or portion of program code that includes instructions that are executable by a processor to implement specific logical functions or steps in a process. The program code may be stored on any type of computer-readable medium, such as non-transitory computer-readable media. In other cases, each block may represent circuitry that is wired to perform specific logical functions or steps in a process. Moreover, the blocks shown in the flow diagrams may be rearranged into different orders, combined into fewer blocks, separated into additional blocks, and/or removed based upon the particular embodiment.

The following description may reference examples where a single data source, such as the asset 200, provides data to the analytics platform 400 that then performs one or more functions. It should be understood that this is done merely for sake of clarity and explanation and is not meant to be limiting. In practice, the analytics platform 400 generally receives data from multiple sources, perhaps simultaneously, and performs operations based on such aggregate received data.

A. Collection of Operating Data

As mentioned above, each of the representative assets 102 and 104 may take various forms and may be configured to perform a number of operations. In a non-limiting example, the asset 102 may take the form of a locomotive that is operable to transfer cargo across the United States. While in transit, the sensors and/or actuators of the asset 102 may obtain data that reflects one or more operating conditions of the asset 102. The sensors and/or actuators may transmit the data to a processing unit of the asset 102.

The processing unit may be configured to receive the data from the sensors and/or actuators. In practice, the processing unit may receive sensor data from multiple sensors and/or actuator data from multiple actuators simultaneously or sequentially. As discussed above, while receiving this data, the processing unit may also be configured to determine whether the data satisfies triggering criteria that trigger any abnormal-condition indicators, such as fault codes. In the event the processing unit determines that one or more abnormal-condition indicators are triggered, the processing unit may be configured to perform one or more local operations, such as outputting an indication of the triggered indicator via a user interface.

The asset 102 may then transmit operating data to the analytics platform 108 via a network interface of the asset 102 and the communication network 106. In operation, the asset 102 may transmit operating data to the analytics platform 108 continuously, periodically, and/or in response to triggering events (e.g., abnormal conditions). Specifically, the asset 102 may transmit operating data periodically based on a particular frequency (e.g., daily, hourly, every fifteen minutes, once per minute, once per second, etc.), or the asset 102 may be configured to transmit a continuous, real-time feed of operating data. Additionally or alternatively, the asset 102 may be configured to transmit operating data based on certain triggers, such as when sensor and/or actuator measurements satisfy triggering criteria for any abnormal-condition indicators. The asset 102 may transmit operating data in other manners as well.

In practice, operating data for the asset 102 may include sensor data, actuator data, abnormal-condition data, and/or other asset event data (e.g., data indicating asset shutdowns, restarts, etc.). In some implementations, the asset 102 may be configured to provide the operating data in a single data stream, while in other implementations the asset 102 may be configured to provide the operating data in multiple, distinct data streams. For example, the asset 102 may provide to the analytics system 108 a first data stream of sensor and/or actuator data and a second data stream of abnormal-condition data. As another example, the asset 102 may provide to the analytics system 108 a separate data stream for each respective sensor and/or actuator on the asset 102. Other possibilities also exist.

Sensor and actuator data may take various forms. For example, at times, sensor data (or actuator data) may include measurements obtained by each of the sensors (or actuators) of the asset 102. While at other times, sensor data (or actuator data) may include measurements obtained by a subset of the sensors (or actuators) of the asset 102.

Specifically, the sensor and/or actuator data may include measurements obtained by the sensors and/or actuators associated with a given triggered abnormal-condition indicator. For example, if a triggered fault code is Fault Code 1 from FIG. 3, then sensor data may include raw measurements obtained by Sensors A and C. Additionally or alternatively, the data may include measurements obtained by one or more sensors or actuators not directly associated with the triggered fault code. Continuing off the last example, the data may additionally include measurements obtained by Actuator B and/or other sensors or actuators. In some examples, the asset 102 may include particular sensor data in the operating data based on a fault-code rule or instruction provided by the analytics system 108, which may have, for example, determined that there is a correlation between that which Actuator B is measuring and that which caused the Fault Code 1 to be triggered in the first place. Other examples are also possible.

Further still, the data may include one or more sensor and/or actuator measurements from each sensor and/or actuator of interest based on a particular time of interest, which may be selected based on a number of factors. In some examples, the particular time of interest may be based on a sampling rate. In other examples, the particular time of interest may be based on the time at which an abnormal-condition indicator is triggered.

In particular, based on the time at which an abnormal-condition indicator is triggered, the data may include one or more respective sensor and/or actuator measurements from each sensor and/or actuator of interest (e.g., sensors and/or actuators directly and indirectly associated with the triggered indicator). The one or more measurements may be based on a particular number of measurements or particular duration of time around the time of the triggered abnormal-condition indicator.

For example, if a triggered fault code is Fault Code 2 from FIG. 3, the sensors and actuators of interest might include Actuator B and Sensor C. The one or more measurements may include the most recent respective measurements obtained by Actuator B and Sensor C prior to the triggering of the fault code (e.g., triggering measurements) or a respective set of measurements before, after, or about the triggering measurements. For example, a set of five measurements may include the five measurements before or after the triggering measurement (e.g., excluding the triggering measurement), the four measurements before or after the triggering measurement and the triggering measurement, or the two measurements before and the two after as well as the triggering measurement, among other possibilities.

Similar to sensor and actuator data, the abnormal-condition data may take various forms. In general, the abnormal-condition data may include or take the form of an indicator that is operable to uniquely identify a particular abnormal condition that occurred at the asset 102 from all other abnormal conditions that may occur at the asset 102. The abnormal-condition indicator may take the form of an alphabetic, numeric, or alphanumeric identifier, among other examples. Moreover, the abnormal-condition indicator may take the form of a string of words that is descriptive of the abnormal condition, such as “Overheated Engine” or “Out of Fuel”, among other examples.

The analytics platform 108, and in particular, the data intake system of the analytics platform 108, may be configured to receive operating data from one or more assets and/or data sources. The data intake system may be configured to intake at least a portion of the received data, perform one or more operations to the received data, and then relay the data to the data analysis system of the analytics platform 108. In turn, the data analysis system may analyze the received data and based on such analysis, perform one or more operations.

B. Generating Recommendations for Repairing an Asset

As one example, the analytics platform 108 may be configured to generate recommendations for repairing a given asset. In general, generating a recommendation for repairing a given asset may involve the analytics platform 108 maintaining and applying a hierarchy of conditions to operating data received from a given asset, such as asset 102.

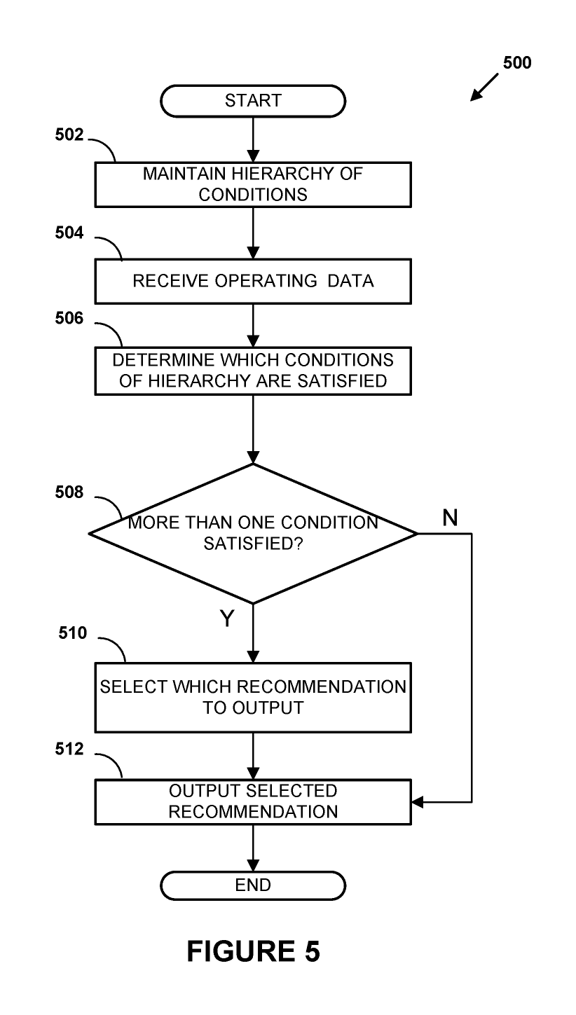

FIG. 5 is a flow diagram 500 that generally depicts one possible example of analyzing a hierarchy of conditions with respect to a given asset's operating data in order to provide a repair recommendation for the given asset. For the purposes of illustration, the example process of analyzing a hierarchy of conditions with respect to a given asset's operating data is described as being carried out by the analytics platform 108, but this example process may be carried out by other devices and/or systems as well. For example, if an asset includes a local analytics device such as the one described above, then such an asset may also be configured to carry out this process either alone or in combination with the analytics platform 108. One of ordinary skill in the art will also appreciate that flow diagram 500 is provided for sake of clarity and explanation and that numerous other combinations of operations may be utilized to determine a recommendation for repairing a given asset.

As shown in FIG. 5, at block 502, the analytics platform 108 may be maintaining a hierarchy of conditions that each correspond to a recommendation for repairing a given aspect of an asset (e.g., a given subsystem) based on operating data. At block 504, the analytics platform 108 may receive operating data (e.g., sensor/actuator data, abnormal-condition data, etc.) for a given asset that relates to the given asset of the given asset. At block 506, the analytics platform 108 may analyze the hierarchy's conditions to determine which one or more conditions (if any) of the hierarchy are satisfied by the operating data for the given asset. In turn, at step 508, the analytics platform 108 may check whether more than one condition of the hierarchy has been satisfied, and thus whether more than repair commendation has been identified. If so, the analytics platform 108 may proceed to block 510 and select the identified recommendation having the highest level of precision (e.g., most granular recommendation). Alternatively, if only one condition is satisfied, the analytics platform 108 may simply select the one recommendation corresponding to the one condition. Lastly, the analytics platform 108 may proceed to block 512 and cause the selected recommendation having the to be output by the computing device. These functions will now be described in further detail below.

Starting at block 502, the analytics platform 108 may be maintaining a hierarchy of conditions that correspond to recommendations for repairing a given aspect of an asset (e.g., subsystem) based on operating data. In practice, a given hierarchy may comprise conditions corresponding to at least two levels of recommendations having differing levels of precision for repairing the same general asset-related issue (i.e., a failure or asset malfunction).

For instance, in accordance with one example embodiment, the hierarchy may include at least (1) a first condition that corresponds to a first repair recommendation having a first level of precision, and (2) a second condition that corresponds to a second repair recommendation having a second level of precision, where the first and second levels of precision differ (e.g., the first level of precision may be higher than the second level of precision, in which case the first recommendation may be more granular than the second recommendation). Moreover, the hierarchy may include one or more other conditions, each of which may correspond to a repair recommendation having the first level of precision, the second level of precision, or some other level of precision. In this respect, a given precision level of the hierarchy could possibly include more than condition and thus more than one repair option. (It should also be understood that, while the terms “first” and “second” are used to describe the hierarchy's levels here, this does not necessarily mean that these levels exist consecutively within the hierarchy, and it is possible one or more intermediate levels may exist between the first and second levels).

In example implementations, each of the conditions of the hierarchy may be based on a predefined rule, predictive model, or a combination thereof. For instance, in one embodiment, the first condition may be based on a predefined rule and the second condition may be based on a predictive model (or vice versa). Other embodiments are possible as well

The differing levels of precision between the levels of repair recommendations in the hierarchy may take various forms. As one illustrative example, a repair recommendation having a higher level of precision could be to repair a specific component of a subsystem at the given asset (e.g., a specific mechanical part such as a screw, a cylinder bore, etc.), whereas a repair recommendation having a lower level of precision could be to repair the subsystem more generally (e.g., an engine). There could also be more than two precision levels in the hierarchy, where the recommendation(s) at each intermediate precision level may be less precise than the higher precision level and more precise than lower level. (For the purposes of this description, a higher level of the precision is generally intended to refer to a more precise/granular recommendation whereas a lower level of the precision is generally intended to refer to a less precise/granular recommendation. However, other conventions are also possible.)

Further, as noted above, a given precision level of the hierarchy could possible include a set of different conditions/recommendations. For example, a given level of the hierarchy may include a set of different conditions corresponding to different respective recommendations having the same level of precision, such as recommendations that relate to specific mechanical parts of a given asset (e.g., cylinder bore, oil pan, air intake filter, etc.) or to different subsystems of the given asset (i.e., engine block, engine oil system, air intake system). The aforementioned examples are not meant to be limiting and it is contemplated herein that the difference in precision between recommendations corresponding to the various levels of the hierarchy may vary by any degree, and such recommendations may encompass any portion of a given asset or group of assets.

The aforementioned predefined rule(s) that may serve as the basis for at least one condition of the hierarchy may take a number of forms. In one implementation, for instance, a given predefined rule may be a rule that is defined based on a set of criteria for one or both of abnormal-condition data (e.g., fault codes) and sensor data and, when satisfied, triggers a recommendation for repairing an asset. That is, the given predefined rule may be configured to output the repair recommendations based on the presence of one or more abnormal-condition indicators and/or one or more sensor measurement conditions. In another implementation, a predefined rule may be comprised of a plurality of predefined rules, each defined based on a respective set of criteria for one or both of abnormal-condition data and sensor data. Other examples of predefined rules may also be utilized.

In examples, predefined rules may be defined by a user (e.g., an expert in the field) and/or or by a computing device, among other possibilities. Further, the predefined rules may be stored in the analytics platform's data storage (e.g., database(s) 406 and/or data storage 412) and/or at some other storage location.

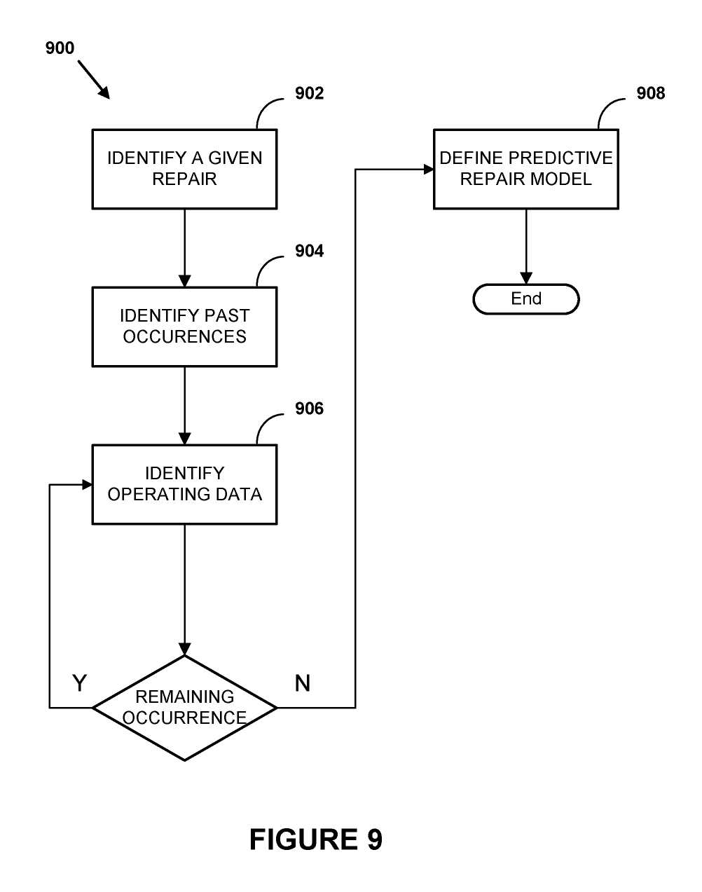

Furthermore, the predictive model(s) that may form the basis of at least one condition of the hierarchy may in general be configured to predict a likelihood that a given repair is needed and/or will be needed in the future based on operating data for an asset. The analytics platform 108 may maintain data defining the predictive model(s) in data storage. The process of defining the predictive model(s) that may form the basis of one or more conditions of the hierarchy will be detailed further below in reference to FIG. 9.

At block 504, while maintaining the hierarchy, the analytics platform 108 may receive data that reflects the current operating conditions of a given asset, such as representative asset 102. In particular, the operating data received by analytics platform 108 may include sensor data, actuator data, and/or abnormal-conditions data, as examples.

At block 506, the analytics platform 108 may analyze the hierarchy's conditions to determine which conditions (if any) are satisfied by the operating data for the given asset. According to one implementation, the analytics platform 108 may analyze the conditions of the hierarchy in parallel to determine which conditions are satisfied by the operating data for the given asset. In another implementation, the analytics platform 108 may analyze the conditions of the hierarchy sequentially, either on a condition-by-condition basis or in batches (e.g., any condition corresponding a recommendation having a first level of precision first, then any condition corresponding a recommendation having a second level of precision next, etc.). In yet another implementation, the analytics platform 108 may make a preliminary selection of which conditions to evaluate based on the nature of the operating data. The analytics platform 108 may analyze the conditions of the hierarchy in other manners as well.

The function of determining whether a given condition of the hierarchy is satisfied by the operating data for the given asset may take also various forms. In line with the discussion above, at least one condition of the hierarchy may be based on a predefined rule, in which case determining whether such a condition is satisfied may generally involve determine whether the predefined rule has been satisfied with a sufficient level of confidence.

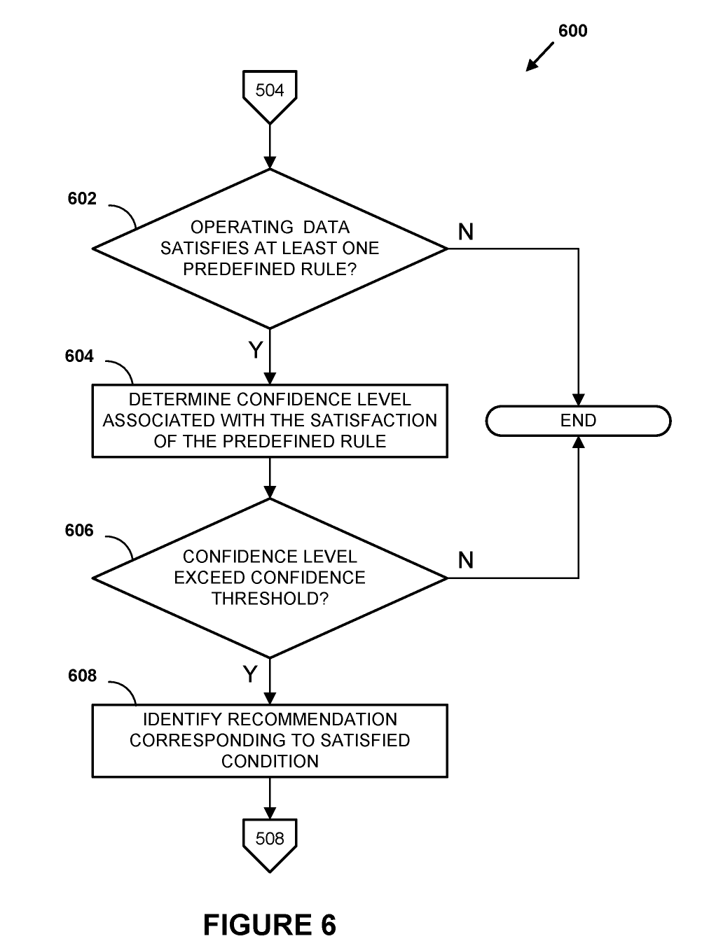

FIG. 6 depicts one possible example of analyzing a condition of the hierarchy that is based on a predefined rule. At block 602, the analytics platform 108 may determine whether the received operating data for the asset 102 satisfies at least one condition based on a predefined rule for providing a repair recommendation.

In one implementation, an affirmative determination at block 602 that the predefined rule is satisfied may also mean that the condition of the hierarchy based on the predefined rule is also satisfied. In such an implementation, the process depicted in FIG. 6 may proceed directly from block 602 to block 608, thereby causing analytics platform 108 to identify the recommendation corresponding to the satisfied condition.

In another implementation, an affirmative determination at block 602 that the at least one predefined rule is satisfied may cause analytics platform 108 to perform additional functions in order to determine whether the condition based on the predefined rule is satisfied. For instance, as shown in FIG. 6, a determination that the predefined rule is satisfied may cause the analytics platform 108 to proceed to block 604 and determine a confidence level associated with the satisfaction of the predefined rule. Generally, a confidence level may be metric (e.g., a number from 0-100 or a percentage value) that indicates the confidence (or “trustworthiness”) in a determination that, because the predefined rule is satisfied, the first recommendation for repairing the asset 102 is to be identified. This confidence level may take various forms.

According to one embodiment, the confidence level may be a single fixed value that is pre-associated with the predefined rule and its corresponding recommendation. For example, the confidence level for the predefined rule may be determined by a computing system, such as the analytics platform 108, based on historical repair data and/or user input.

One way this might be accomplished is by having the computing system electronically present questionnaires to users (e.g., experts in the field) that enable the computing system to gather information regarding the confidence level associated with the predefined rule. For instance, such a questionnaire may present a set of operating data that satisfies the predefined rule and asks the user to decide whether a given repair is needed in that scenario (e.g., whether the user agrees or disagrees with the repair recommendation). The presented questionnaire may enable a user to input his or her responses in a binary manner (e.g. yes/no, agree/disagree, etc.), upon a Likert-type scale, by assigning a percentage value corresponding to their certainty (e.g. 60% sure a repair is needed, 20% likely that a specific repair recommendation will resolve an issue, etc.), textually in structured or unstructured format, or in some other manner.

The computing system (e.g., analytics platform 108) may then process the responses to the questionnaire in order to determine a confidence level associated with the predefined rule and its corresponding repair recommendation. For instance, this processing may involve grouping response data by scenario and inputting the response data to a computer-based algorithm to output a confidence level for the predefined rule. Additionally, the processing may involve weighting the response data. For example, responses of a user with many years of experience in the field may be afforded greater weight (i.e. impact an aggregate confidence level more significantly) than responses of a user with relatively fewer years of experience. The processing of the response data to determine a confidence level may take other forms as well.

According to another embodiment, the confidence level may vary based on criteria such as the inputs to the predefined rule. For example, as the number of abnormal-condition indicators input to the rule grows and/or the amount by which sensor measurements exceed the rule's criteria increases, the confidence level associated with the predefined rule may also increase. Other examples are possible as well.

In such an embodiment, the determination of the confidence level may also account for other factors, such as the perceived reliability of sensor data. That is, the analytics platform 108 may perceive that certain sensor data may be less or more reliable due to factors such as sensor type, weather conditions an asset is operating in, among others. For example, if a given asset is determined to be operating in an artic environment and one or more particular sensor types are known by analytics platform 108 to output faulty readings in extreme cold conditions, the confidence level that a predefined rule, based at least in part on one or more of those sensor types, is satisfied may be relatively lower than if the asset were determined to be operating in a temperate climate. In another example, analytics platform 108 may be aware that certain sensor types (i.e. brand, model) are inherently unreliable (i.e. prone to error) and may vary the confidence level in relation to the satisfaction of the predefined rule accordingly. Other examples are possible.

In practice, the analytics platform 108 may be made aware the sensor type and other conditions (e.g. weather, asset type, asset age) that may affect the reliability of the sensor data through analyzing metadata corresponding to the received operating data. The analytics platform 108 may then compare the results of the metadata analysis to sensor reliability data that may be stored in data storage to determine if any adjustments to a confidence level should be made. Other methods and configurations may also be employed.

Still further, the analytics platform 108 may vary the confidence level for the predefined rule dynamically based on user feedback. For instance, after a repair recommendation is triggered by the predefined rule, a user may provide feedback, via an output system such as the output system 110, to analytics platform 108 indicating an opinion as to whether they agree or disagree with the repair recommendation. Such feedback, in some examples, may take the form of a binary value (e.g. yes, no) or percentage levels (e.g. 70% confident in the recommendation) and may be based on, for instance, the success of an outputted repair recommendation addressing an asset-related issue, among other possibilities. Upon receiving such feedback, the analytics platform 108 may identify the predefined rule the feedback is directed to and adjust the confidence level corresponding to the identified predefined rule accordingly.

At block 606, the analytics platform 108 may compare the determined confidence level associated with the satisfaction of the predefined rule to a confidence level threshold and thereby determine whether the confidence level exceeds the confidence level threshold.

The confidence level threshold represented at block 606, in essence, is a numerical value that serves as a gatekeeper to prevent the output of a recommendation that is unnecessary and/or unlikely to result in an asset related issue being solved. In some examples, the confidence level threshold may be a value that is defined by a user, the analytics system 108, and/or some other computer system based on various considerations.

If the analytics platform 108 determines at block 606 that the confidence level associated with the satisfaction of the predefined rule exceeds the confidence level threshold, and thus that the condition of the hierarchy based on the predefined rule is satisfied, the analytics platform 108 may proceed to block 608 and identify the recommendation corresponding to the condition. Alternatively, if the analytics platform 108 determines at block 610 that the confidence level associated with the satisfaction of the predefined rule does not exceed the confidence level threshold, and thus that the condition is not satisfied, the analytics platform 108 may end the analysis depicted in FIG. 6 or continue to analyze remaining conditions of the hierarchy based on predefined rules and/or predictive models.

While the discussion above focuses on an implementation where a given condition is based on a single predefined rule, there may be another implementation where the given condition is based on a plurality of predefined rules. In such an implementation, the determination at block 602 may take the form of a determination that the operating data satisfies any one of the plurality of predefined rules, a determination that the operating data satisfies some threshold number of the plurality of predefined rules, or a determination that the operating data satisfies all of the plurality of predefined rules. Similarly, the determination at block 606 may take the form of a determination that the confidence level associated with any one of the plurality of predefined rules exceeds the confidence level threshold, a determination that the confidence level associated with some threshold number of the plurality of predefined rules exceeds the confidence level threshold, or a determination that the confidence level associated with all of the plurality of predefined rules exceeds the confidence level threshold. In this respect, the confidence level threshold used for each of the plurality of predefined rules may either be the same or may vary based on the underlying predefined rule (i.e. unique confidence level thresholds for individual predefined rules).

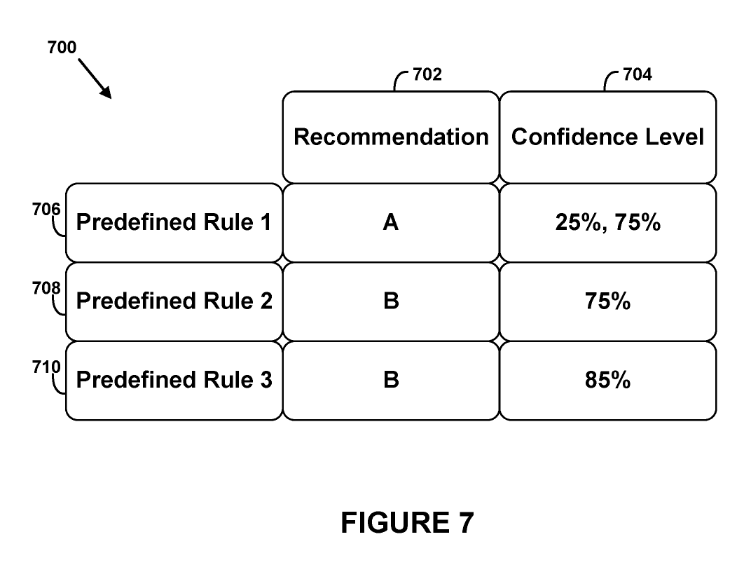

FIG. 7 depicts a conceptual illustration of a plurality of predefined rules and associated confidence levels that may form the basis for a hierarchy's first condition. As shown, table 700 includes columns 702 and 704 that correspond to recommendations and confidence levels, respectively, and rows 706, 708, and 710 that correspond to Predefined Rules 1, 2, and 3, respectively. Entries at the intersection of the columns and rows specify recommendations and confidence levels that correspond to each predefined rule. FIG. 7 will be now be used to further explain the example process described above with reference to FIG. 6.

As shown in FIG. 7, the predefined rules identified in rows 706-710 may trigger the respective recommendations for repairing an asset identified in column 702. For example, Predefined Rule 1 (706) may trigger Recommendation A (e.g., repairing an engine screw), whereas Predefined Rules 2 and 3 (708, 710) may both trigger Recommendation B (e.g., repairing an engine spark plug). Furthermore, the predefined rules may be associated with the confidence levels of column 704. For example, Predefined Rules 2 and 3 both have fixed confidence levels, whereas Predefined Rule 1 (706) has a variable confidence level (25% or 75%) that depends on the inputs to the rule. As described above, these confidence levels may be determined in various manners.

For purposes of illustration, the following example assumes that Predefined Rule 1 (706), which corresponds to Recommendation A, requires the presence of sensor Fault Codes 1 (308) and 3 (312) of FIG. 3 to be satisfied. That is, Predefined Rule 1 (706) may be satisfied when the received Sensor A (302) value is greater than 135 RPM, received Actuator B value is greater than 750V, and the received Sensor C value is greater than 65° C. As such, Predefined Rule 1 may be minimally satisfied by the received sensor values barely exceeding the threshold sensor values (i.e. Sensor A=136 RPM, Actuator B=76V, and Sensor C=66° C.), or may be satisfied to a greater degree as one or more of the received sensor values increases (i.e., sensor A=180 RPM, Actuator B=800V sensor C=80° C.). In such an example, the analytics platform 108 may take into account the degree by which Predefined Rule 1 is satisfied to determine the associated confidence level. For example, the analytics platform 108 may select a lower confidence level (25%) when the Predefined Rule 1 (706) is minimally satisfied and a higher confidence level (75%) when the Predefined Rule 1 (706) is satisfied by a greater degree. The previous example is not intended to be limiting as the confidence level may be varied based on various criteria.

As discussed above, in one implementation, the analytics platform 108 may use a predefined rule's confidence level to determine whether to output the rule's repair recommendation. For example, if Predefined Rule 3 (710) is determined to be satisfied with an associated confidence level of 85% and the confidence level threshold is 80%, the analytics platform 108 may determine that the confidence level threshold has been exceeded and may thus output an indication of Recommendation B. On the other hand, if Predefined Rule 2 (708) is determined to be satisfied with its associated confidence level of 75% and the confidence level threshold is 80%, analytics platform 108 may determine that the confidence level threshold has not been exceeded and may not output an indication of Recommendation B.

Referring back to FIG. 5, at least one other condition of the hierarchy may be based on a predictive model, in which case determining whether such a condition is satisfied may generally involve determining whether the predictive model's output meets a given confidence threshold.

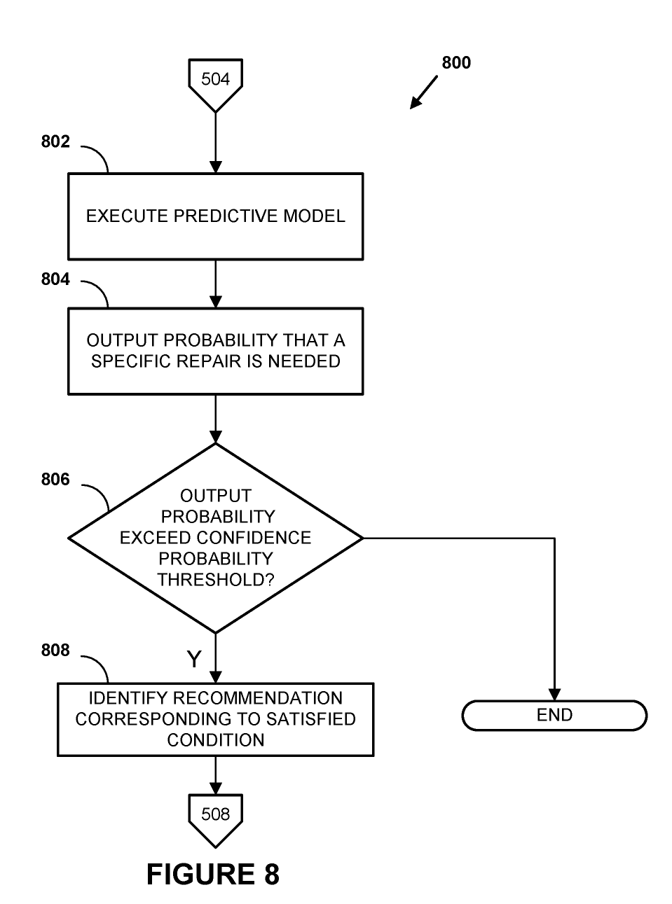

FIG. 8 depicts one possible example of analyzing a given condition of the hierarchy that is based on a predictive model. In general, the predictive model may be configured to predict a likelihood that a given repair is needed and/or will be needed in the future based on operating data for an asset.

At block 802, the analytics platform 108 may execute the predictive model by inputting the operating data for the asset 102 into the predictive model. In turn, at block 804, the predictive model may cause the analytics platform 108 to determine and output an indicator of a likelihood (e.g., a probability value between 0-1) that a given repair is needed and/or will be needed in the future at the asset 102.

At block 806, the analytics platform 108 may determine whether the outputted likelihood indicator exceeds a confidence level threshold. As with the previously-mentioned confidence level threshold, this confidence level threshold may be a probability value (e.g. a value between 0-1) that defines the likelihood level at which a repair recommendation is to be identified by the analytics platform 108. Also, as with the previously-mentioned confidence level threshold, this confidence level threshold may be a fixed or variable value that is defined by a computing device or a user.

If the analytics platform 108 determines at block 806 that the outputted likelihood indicator exceeds a confidence level threshold, the analytics platform 108 may then proceed to block 808 and identify a recommendation corresponding to the given condition. Alternatively, if the analytics platform 108 determines that the outputted likelihood indicator does not exceed the confidence level threshold, then the analytics platform 108 may end the analysis of the given condition.

In line with the discussion above, the hierarchy of conditions may include multiple conditions that are each based on a respective predictive model, in which case the analytics platform 108 may perform this analysis for each such condition.

In some implementations, a condition could also be based on a predictive model that is capable of calculating respective likelihood values for multiple different repair options (which may have the same precision level or different precision levels). In such an implementation, the analytics platform's analysis of the condition may additionally involve identifying the repair option with the highest likelihood value.

Returning again to FIG. 5, after the data analytics system 108 has analyzed the hierarchy's conditions at block 506, the analytics platform 108 may proceed to block 508 to check whether more than one condition of the hierarchy has been satisfied, and thus whether more than repair recommendation has been identified. If so, the analytics platform 108 may then proceed to block 510 to select which recommendation to output. (Alternatively, if the analytics platform 108 determines only one condition was satisfied and thus only one recommendation was identified, the analytics platform 108 may skip block 510).

In accordance with the present disclosure, the analytics platform 108 will preferably be configured to select, from the identified more than one recommendation, the recommendation having the highest level of precision (e.g., most granular recommendation). For example, if the analytics platform 108 identifies a first recommendation directed to a specific aspect of a subsystem (e.g. a screw) and a second recommendation directed to the subsystem more generally (e.g., an engine), the analytics platform 108 may be configured to select the first recommendation because it has a higher level of precision relative to the second recommendation. Various other examples are possible.

It should also be understood that, in some situations, the analytics platform's analysis could result in the identification of two or more different recommendations having the same level of precision, which may be identified as the highest level of precision of the identified recommendations. In such a situation, the analytics platform's selection of the recommendation at block 510 may additionally involve selecting between two recommendations having the same level of precision. According to one implementation, the analytics platform 108 could be configured to perform this selection based on a set of one or more “tie-breaker” rules, which may take various forms.

In one instance, a “tie-breaker” rule may be based on a type of conditions to which the identified recommendations correspond, and in particular, whether the conditions are based on a predefined rule, a predictive model, or the like. For example, such a “tie-breaker” rule may specify that for recommendations having the same level of precision, a recommendation corresponding to a condition based on a predictive model takes precedence over a recommendation corresponding to a condition based on a predefined rule.

In another instance, a “tie-breaker” rule may be based on the confidence level associated with an identified recommendation corresponding to a condition based on a predefined rule (see block 604) and/or the outputted likelihood associated with a condition based on a predictive model (see block 808). For example, such a “tie-breaker” rule may specify that for recommendations having the same level of precision, a recommendation corresponding to a highest confidence level/outputted likelihood value takes precedence.

The “tie-breaker” rules may take various other forms as well, including the possibility that the two or more different types of “tie-breaker” rules may be combined together.

In another implementation, instead of selecting between two or more identified recommendations each having the highest level of precision, the analytics system 108 may be configured to select all such recommendations for output.

After selecting a recommendation, the analytics system 108 may proceed to block 512 and cause the selected repair recommendation to be output to a computing device. This function of causing the repair recommendation to be output may take various forms. In one implementation, the analytics platform may output the recommendation for repairing an asset to the output system 110, and this may in turn cause the output system 110 to output various information regarding the recommendation for repairing an asset corresponding. Such outputted information may take the form of a visual or audio output. For example, the outputted information may include an identification of the repair that is needed and perhaps also instructions to perform the repair, among other possibilities.

In another implementation, the analytics platform may output the recommendation for repairing an asset to the output system 110, and this may in turn cause the output system 110 to perform one or more actions to facilitate repairing the asset, such as automatically ordering parts required by the repair recommendation and/or automatically scheduling a time, shop location, and/or technician to perform the repair corresponding to the recommendation. Other examples of triggered actions are possible.

Turning now to FIG. 9, a flow diagram is shown that depicts one possible example of defining a predictive model for outputting an indicator of the likelihood that a given repair is or may be needed at an asset. For purposes of illustration, the process of defining the predictive model is described as being carried out by the analytics platform 108, but the predictive model may be defined by other systems as well. One of ordinary skill in the art will appreciate that the flow diagram 900 is provided for sake of clarity and explanation and that numerous other combinations may be utilized to define a model that may predict the likelihood that a given repair is or may be needed.

As shown in FIG. 9, at block 902, the analytics platform 108 may begin by identifying a given repair to be recommended when the second condition is satisfied. In practice, the given repair may be utilized to address a variety of asset-related issues such as faults, failures, and non-optimal operation, among other possibilities. In turn, the analytics platform 108 may then define a model for predicting a likelihood that the given repair is needed and/or will be needed in the future.

In particular, at block 904, the analytics platform 108 may analyze historical repair data for a group of one or more assets to identify past occurrences of the given repair. At block 906, analytics platform 108 may identify a respective set of historical operating data that is associated with each identified past occurrence of the given repair (e.g., abnormal-condition data and/or sensor data from a timeframe shortly before and/or after the occurrence of the given repair).

At block 908, the analytics platform 108 may then analyze the identified sets of historical operating data associated with past occurrences of the given repair to define a relationship between (1) the values for a given set of operating data parameters (e.g., abnormal-condition indicators and/or sensor values) and (2) the likelihood of the given repair being needed currently and/or within a timeframe in the future. This relationship may be stored as the predictive model for the given repair.

As the analytics platform 108 continues to receive historical repair and operating data for the group of one or more assets, the analytics platform 108 may also continue to refine the predictive model for the given repair by repeating blocks 904-908.

The functions of the example definition phase in FIG. 9 will now be describe in further detail. Starting with block 902, as noted above, the analytics platform 108 may begin by identifying a given repair to be recommended when the second condition is satisfied. The analytics platform 108 may perform this function in various manners.

In one implementation, the given repair may be identified based on user input. For example, the analytics platform 108 may receive from a computing device operated by a user, such as output system 108, input data indicating a user selection of the given repair.

In another implementation, the given repair may be identified based on determinations made by the analytics platform 108. For example, the analytics platform 108 may be configured to identify the given repair based on information regarding the particular hierarchy being defined, the particular types of assets in the system, etc. As another example, the analytics platform 108 may be configured to identify the given repair based on historical repair data. Other examples are possible as well.

In yet another implementation, the given repair may be identified based on a combination of user inputs and determinations made by the analytics platform 108. Other implementations are also possible.

At block 904, the analytics platform 108 may analyze historical repair data for a group of one or more assets to identify past occurrences of the given repair. The group of the one or more assets may include a single asset, such as asset 102, or multiple assets that may be of the same or similar type, such as a fleet of assets. The analytics platform 108 may analyze a particular amount of historical repair data, such as a certain amount of time's worth data (e.g. a month's worth) or a certain number of data-points (e.g., the most recent thousand data-points), among other examples. In practice, the analytics platform 108 may search the historical repair data for indicators that represent the given repair, such as a repair code or a textual description of the given repair. For each occurrence of the given repair that is located in the historical repair data, the analytics platform 108 may record identifying information for that occurrence such as the given asset at which the repair was made, the time at which the repair was made, etc.

At block 906, the analytics platform 108 may identify a set of respective operating data that is associated with each identified past occurrence of the given repair. In particular, the analytics platform 108 may identify a set of historical operating data (e.g., abnormal-condition data and/or sensor data) from a certain timeframe around the time of the given occurrence of the given repair. For example, the set of data may be from a particular timeframe (e.g. two weeks) before, after, or around the given occurrence of the given repair. In other cases, the set of data may be identified from a certain number of data-points before, after, or around the given occurrence of the repair. Other examples are possible as well. Further, in practice, the analytics platform 108 either may identify all historical operating data for the asset 102 in the identified timeframe or may obtain a subset of the historical operating data for the asset 102 in the identified timeframe (e.g., only abnormal-condition data and/or sensor data that relates to the given repair).

In addition to the methods described above, the analytics platform 108 may identify a set of respective operating data that consists of continuous signal data and asynchronous event data by utilizing the methods for pattern matching of time series arrays described in U.S. patent application Ser. No. 14/996,154, which is incorporated by reference herein in its entirety. These methods identify one or more historical time series data arrays similar to the operating data for the recommended repair. Then associated event data particular to the historical repairs, e.g., data from oil sample results, results of system tests performed by mechanics, parts utilized in the repair, may be utilized to filter the one or more historical time series data arrays to obtain the one or more filtered historical time series data arrays that are most relevant to the recommended repair.

After the analytics platform 108 identifies the set of operating data for the given occurrence of a given repair, the analytics platform 108 may determine whether there are any remaining occurrences for which a set of operating data should be identified. In the event that there is a remaining occurrence, block 906 would be repeated for each remaining occurrence.

Thereafter, at block 908, the analytics platform 108 may analyze the identified sets of historical operating data associated with the past occurrences of the given repair to define a relationship between (1) a given set of operating data parameters and (2) the likelihood of the given repair being needed currently and/or within the given timeframe in the future. This defined relationship may embody the predictive model for the given repair.

In practice, this relationship (and thus the predictive model) may be defined in a number of manners. In example implementations, the analytics platform 108 may define the predictive model by utilizing one or more modeling techniques that return a probability between zero and one, such as a random forest technique, logistic regression technique, or other regression techniques. Other examples are possible as well.

In a particular example, defining the predictive model may involve the analytics platform 108 implementing a localized temporal model of U.S. patent application Ser. No. 14/996,154, which as noted above is incorporated by reference. The filtered historical time series data arrays that are most relevant to the recommended repair are used to train a time series forecast model, which then generates a forecast of one or more future values of at least one operating data parameters. The predicted future values of operating data parameters may be associated with a probability between zero and one that a given repair is needed within the timeframe in the future.

In another example, defining the predictive model may involve the analytics platform 108 generating a response variable based on the historical operating data identified at 906. Specifically, the analytics platform 108 may determine an associated response variable for each set of operating data received at a particular point in time. As such, the response variable may take the form of a data set associated with the predictive model.

The response variable may indicate whether the given set of operating data is within any of the timeframes identified at block 906. That is, a response variable may reflect whether a given set of operating data is from a time of interest about the occurrence of a repair. The response variable may be a binary-values response variable such that if the given set of operating data is within any of the determined timeframes, the associated response variable is assigned a value of one, and otherwise, the associated response variable is assigned a value of zero.

Continuing in the particular example of defining the predictive model based on a response variable, the analytics platform 108 may train the predictive model with the historical operating data identified at block 906 and the generated response variable. Based on this training process, the analytics platform 108 may then define the predictive model that receives as inputs various operating data and outputs a probability between zero and one that a repair is needed within a timeframe equivalent to the timeframe used to generate the response variable.

In some cases, training with the historical operating data identified at block 906 and the generated response variable may result in variable importance statistics for each operating data parameter. A given variable importance statistic may indicate the operating data parameter's relative effect on the probability that the given repair is or will be needed.

Additionally or alternatively, the analytics platform 108 may be configured to define the predictive model based on one or more survival analysis techniques, such as a Cox proportional hazard technique. The analytics platform 108 may utilize a survival analysis technique similarly in some respects to the above-discussed modeling technique, but the analytics platform 108 may determine a survival time-response variable that indicates an amount of time from the last failure to a next expected event. A next expected event may be either reception of operating data or an occurrence of a repair, whichever occurs first. This response variable may include a pair of values that are associated with each of the particular points in time at which operating data is received. The response variable may then be utilized to determine a probability that the given repair is or will be needed.

In some implementations, in addition to the received operating data, the predictive model may also be defined based on other data. For example, the predictive model may be defined based on features, which may be derived from the operating data. Examples of such features may include an average range of sensor values that were historically measured when a repair was needed, an average range of sensor-values gradients (e.g., a rate of change in sensor measurements) that were historically measured prior to an occurrence of a repair being needed, a duration of time between repairs (e.g., an amount of time or number of data-points between a first occurrence of a repair and a second occurrence of a repair), and/or one or more patterns indicating sensor measurements around the occurrence of a failure. One of ordinary skill in the art will appreciate that these are but a few example features that can be derived from operating data and that numerous other features are possible.

As another example, the predictive model may be defined based in part on external data, such as weather data and/or “hot box” data, among other data. For instance, based on such data, the predictive model may increase or decrease the likelihood that a repair is needed.

In practice, external data may be observed at points in time that do not coincide with times at which the operating data was captured. For example, the time at which “hot box” data is collected (e.g., time at which a locomotive passes along a section of railroad track that is outfitted with hot box sensor) may be in disagreement with operating data times. In such cases, the analytics platform 108 may be configured to perform one or more operations to determine external data observations that would have been observed at time that correspond to the sensor measurement times.

Specifically, the analytics platform 108 may utilize the times of the external data observations and times of the operating data to interpolate the external data observations to produce external values for times corresponding to the operating data times. Interpolation of the external data may allow external data observations or features derived therefrom to be included as inputs into the predictive model. In practice various techniques may be used to interpolate the external data with the operating data, such as nearest-neighbor interpolation, linear interpolation, polynomial interpolation, and spline interpolation, among other examples.

It should also be understood that the analytics platform 108 may repeat blocks 902-908 to define a predictive model for each of a plurality of different repair options. As noted above, it may also be possible to define a predictive model that is capable of outputting likelihood values for multiple different repair options.

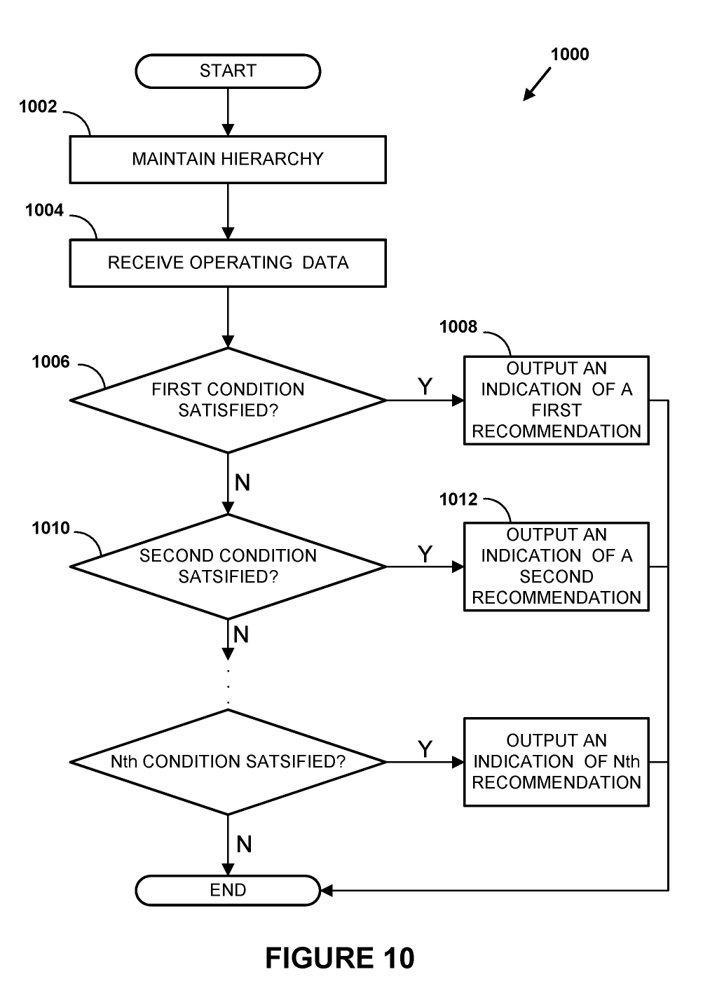

Turning now to FIG. 10, another example process is shown that may serve an alternative implementation for the process discussed above in reference to FIG. 5. For the purposes of illustration, this example process of is also described as being carried out by the analytics platform 108, but this example process may be carried out by other devices and/or systems as well. For example, if an asset includes a local analytics device such as the one described above, then such an asset may also be configured to carry out this process either alone or in combination with the analytics platform 108. One of ordinary skill in the art will also appreciate that flow diagram 1000 is provided for sake of clarity and explanation and that numerous other combinations of operations may be utilized to determine a recommendation for repairing a given asset.

As shown in FIG. 10, at block 1002, the analytics platform 108 may be maintaining a hierarchy of conditions that correspond to respective recommendations for repairing an asset based on operating data. In the example process depicted in FIG. 10, the hierarchy may include at least (1) a first condition that is based on a predefined rule and corresponds to a first repair recommendation having a higher level of precision and (2) a second condition that is based on a predictive model and corresponds to a second repair recommendation having a lower level of precision. However, this example hierarchy may take various other forms as well, including the possibility that the first condition is based on a predictive model and the second condition is based on a predefined rule, that the first and second conditions are both based on a predefined rule, and that the first and second conditions are both based on a predictive model.

At block 1004, while maintaining the hierarchy, the analytics platform 108 may receive data that reflects the current operating conditions of a given asset.

At block 1006, the analytics platform 108 may utilize the received operating data to determine whether the first condition of the hierarchy is satisfied (e.g., in a manner similar to that discussed above with reference to FIG. 6). If analytics platform 108 determines that the first condition of the hierarchy of conditions is satisfied, then at block 1008, the analytics platform 108 may cause an indication of the first recommendation having the higher level of precision to be output by the output system 110.

On the other hand, if the analytics platform 108 determines that the first condition of the hierarchy of conditions is not satisfied, the process may proceed to block 1010 to determine whether the second condition of the hierarchy is satisfied (e.g., in a manner similar to that discussed above with reference to FIG. 8). If the analytics platform 108 determines at block 1010 that the second condition is satisfied, then at block 1012, the analytics platform 108 may cause an indication of the second recommendation having the lower level of precision to be output by the output system 110.

If the second condition is also not satisfied, the analytics platform 108 may then continue to proceed through any other levels of the hierarchy sequentially until (1) a condition is found to be satisfied or (2) all the conditions of the hierarchy fail to be satisfied. In other implementations, analytics platform 108 may process the conditions of the hierarchy simultaneously or batches of conditions sequentially.

As shown in FIG. 10, in some implementations, the analytics platform 108 may terminate the example process after identifying a recommendation for output. In other implementations, the analytics platform 108 may continue to proceed through lower levels of the hierarchy even after identifying a recommendation for output at a higher level of the hierarchy.

While FIG. 10 is discussed in the context of an example hierarchy having one condition/recommendation per level of precision, it should again be understood that a hierarchy may include multiple conditions/recommendations per level of precision. For example, such a hierarchy may include (1) a first set of conditions that each correspond to a respective repair recommendation having a first level of precision and (2) a second set of conditions that each correspond to a respective repair recommendation having a second level of precision, where the first and second levels of precision differ. In such an example, the analytics platform 108 may analyze each of the first set of conditions at block 1006, and if more than one of the first set of conditions is satisfied, the analytics platform 108 may use a “tiebreaker rule” such as those described above to select which recommendation to output at block 1008. Further, if none of the first set of conditions is satisfied at block 1006, the analytics platform 108 may perform a similar analysis for the second set of conditions/recommendations.

### V. Conclusion

Example embodiments of the disclosed innovations have been described above. Those skilled in the art will understand, however, that embodiments may be combined and that changes and modifications may be made to the embodiments described without departing from the true scope and sprit of the present invention, which will be defined by the claims.

Further, to the extent that examples described herein involve operations performed or initiated by actors, such as “humans”, “operators”, “users” or other entities, this is for purposes of example and explanation only. The claims should not be construed as requiring action by such actors unless explicitly recited in the claim language.

1. A computing system comprising:
at least one processor;
a non-transitory computer-readable medium; and
program instructions stored on the non-transitory computer-readable medium that are executable by the at least one processor to cause the computing system to:
maintain a hierarchy of conditions that correspond to recommendations for repairing an asset based on operating data, wherein the hierarchy comprises at least (1) a first condition that is based on a predefined rule and corresponds to a first repair recommendation having a first level of precision and (2) a second condition that is based on a predictive model and corresponds to a second repair recommendation having a second level of precision, wherein the first and second levels of precision differ;
receive operating data for a given asset of a plurality of assets;
determine that the first and second conditions of the hierarchy are satisfied by the received operating data and thereby identifying the first and second recommendations;
identify which one of the first and second recommendations has a higher level of precision; and
cause a computing device to output an indication of the identified one of the first and second recommendations.

2. The computing system of claim 1, wherein the hierarchy further comprises a third condition that corresponds to a third repair recommendation having a third level of precision.

3. The computing system of claim 2, wherein the third level of precision is the same as either the first level of precision or the second level of precision.

4. The computing system of claim 1, wherein the program instructions that are executable by the at least one processor to cause the computing system to cause the computing device to determine that the first condition is satisfied by the received operating data comprise program instructions that are executable by the at least one processor to cause the computing system to:
determine that the received operating data satisfies the predefined rule;
identify a confidence level associated with satisfaction of the predefined rule; and
determine that the identified confidence level exceeds a confidence level threshold.

5. The computing system of claim 4, wherein the confidence level associated with the predefined rule is based at least in part on user input.

6. The computing system of claim 1, wherein the program instructions that are executable by the at least one processor to cause the computing device to determine that the second condition is satisfied by the received operating data comprise program instructions that are executable by the at least one processor to cause the computing device to:
apply the predictive model to the received operation data; and
determine that an output of the predictive model exceeds a confidence level threshold.

7. The computing system of claim 1, wherein the predictive model comprises a predictive model for outputting an indication of a likelihood that a given repair is needed at an asset based on operating data for the asset.

8. The computing system of claim 1, wherein the predictive model is defined based at least on historical repair data and historical operating data for a plurality of assets.

9. A non-transitory computer-readable medium having program instructions stored thereon that are executable to cause a computing device to:
maintain a hierarchy of conditions that correspond to recommendations for repairing an asset based on operating data, wherein the hierarchy comprises at least (1) a first condition that is based on a predefined rule and corresponds to a first repair recommendation having a first level of precision and (2) a second condition that is based on a predictive model and corresponds to a second repair recommendation having a second level of precision, wherein the first and second levels of precision differ;
receive operating data for a given asset of a plurality of assets;
determine that the first and second conditions of the hierarchy are satisfied by the received operating data and thereby identifying the first and second recommendations;
identify which one of the first and second recommendations has a higher level of precision; and
cause a computing device to output an indication of the identified one of the first and second recommendations.

10. The non-transitory computer-readable medium of claim 9, wherein the hierarchy further comprises a third condition that corresponds to a third repair recommendation having a third level of precision.

11. The non-transitory computer-readable medium of claim 10, wherein the third level of precision is the same as either the first level of precision or the second level of precision.

12. The non-transitory computer-readable medium of claim 9, wherein the program instructions that are executable to cause a computing device to determine that the first condition is satisfied by the received operating data comprise program instructions that are executable to cause a computing device to:
determine that the received operating data satisfies the predefined rule;
identify a confidence level associated with the predefined rule; and
determine that the identified confidence level exceeds a confidence level threshold.

13. The non-transitory computer-readable medium of claim 12, wherein the confidence level associated with the predefined rule is based at least in part on user input.

14. The non-transitory computer-readable medium of claim 9, wherein the program instructions that are executable to cause a computing device to determine that the second condition is satisfied by the received operating data comprise program instructions that are executable to cause a computing device to:
apply the predictive model to the received operation data; and
determine that an output of the predictive model exceeds a confidence level threshold.

15. The non-transitory computer-readable medium of claim 9, wherein the predictive model comprises a predictive model for outputting an indication of a likelihood that a given repair is needed at an asset based on operating data for the asset.

16. A computer-implemented method comprising:
maintaining a hierarchy of conditions for generating a recommendation based on operating data for an asset, wherein the hierarchy comprises at least (1) a first condition that is based on a predefined rule and corresponds to a first repair recommendation having a first level of precision and (b) a second condition that is based on a predictive model and corresponds to a second repair recommendation having a second level of precision, wherein the first and second levels of precision differ;
receiving operating data for a given asset of a plurality of assets; and
determining that the first and second recommendation are satisfied by the received operating data and thereby identifying the first and second recommendations;
identifying which one of the first and second recommendations has a higher level of precision; and
causing a computing device to output an indication of the identified on of the first and second recommendations.

17. The computer-implemented method of claim 16, wherein determining that the first condition is satisfied by the received operating data comprises:
determining that the received operating data satisfies the predefined rule;
identifying a confidence level associated with the predefined rule; and
determining that the identified confidence level exceeds a confidence level threshold.

18. The computer-implemented method of claim 16, wherein determining that the second condition is satisfied by the received operating comprises:
applying the predictive model to the received operation data; and
determining that an output of the predictive model exceeds a confidence level threshold.

19. The computer-implemented method of claim 16, wherein the predictive model comprises a predictive model for outputting an indication of a likelihood that a given repair is needed at an asset based on operating data for the asset.

20. The computer-implemented method of claim 16, wherein the predictive model is defined based at least on historical repair data and historical operating data for a plurality of assets.
